(19) United States
(12) Patent Application Publication
(10) Pub. No.: US 2025/0303744 A1
(43) Pub. Date: Oct. 2, 2025

(54) PRINTING DEVICE AND PRINTING METHOD

(71) Applicant: SEIKO EPSON CORPORATION, Tokyo (JP)

(72) Inventors: Hiroyuki USHIAMA, CHINO-SHI (JP); Masashi YASUI, MATSUMOTO-SHI (JP)

(21) Appl. No.: 19/089,949

(22) Filed: Mar. 25, 2025

(30) Foreign Application Priority Data
Mar. 27, 2024 (JP) 2024-050712

(51) Int. Cl. B41J 2/21; G06K 15/02

(52) U.S. Cl. CPC B41J 2/2135; B41J 2/2121; G06K 15/027; G06K 2215/101

(57) ABSTRACT

A transfer unit relatively moves a medium in a relative movement direction intersecting a nozzle arrangement direction with reference to a print head. In an overlapping portion of the print head, a first nozzle array is positioned more upstream in the relative movement direction than a second nozzle array. in the nozzle arrangement direction, a boundary between a first print region by the first nozzle array and a second print region by the second nozzle array is within a range of the overlapping portion. A plurality of first nozzles include a normal nozzle present in the first print region, and an anti-flow dot forming nozzle present at an end portion at a side of the first print region in the second print region. A control unit causes the print head to form a plurality of anti-flow dots not adjacent to each other in the relative movement direction by a first liquid discharged from the anti-flow dot forming nozzle onto the medium during printing.

The present application is based on, and claims priority from JP Application Serial Number 2024-050712, filed Mar. 27, 2024, the disclosure of which is hereby incorporated by reference herein in its entirety.

### BACKGROUND

### 1. Technical Field

The present disclosure relates to a printing device including an overlapping portion in which nozzle arrays partially overlap each other, and a printing method.

### 2. Related Art

JP-A-2014-195897 discloses a printer configured to perform printing using a printing unit in which a first nozzle array group and a second nozzle array group are arranged in a direction intersecting a predetermined direction. In the first nozzle array group, first nozzle arrays in which first nozzles configured to discharge a first liquid are arranged in the predetermined direction are arranged in the predetermined direction, and end portions of adjacent first nozzle arrays overlap each other. In the second nozzle array group, second nozzle arrays in which second nozzles configured to discharge a second liquid are arranged in the predetermined direction are arranged in the predetermined direction, and end portions of adjacent second nozzle arrays overlap each other.

In the printer, an error occurs in attachment position in the predetermined direction in the nozzle array group that discharges different liquids, or an error occurs in attachment position in the predetermined direction among the nozzle arrays that discharge the same liquid. The error among the nozzle arrays that discharge the same liquid causes density unevenness such as a black streak and a white streak in a print result by the overlapping portion of the nozzle arrays that discharge the same liquid.

In the first nozzle array and the second nozzle array configured to discharge the same liquid, even if a use range of the first nozzle and the second nozzle in the overlapping portion is determined such that the print region by the first nozzle array and the print region by the second nozzle array are continuous, a light streak in which a background color component of the medium appears, such as a white streak, may occur. Therefore, there is a demand for improvement for eliminating a light streak due to an overlapping portion of nozzle arrays configured to discharge the same liquid.

### SUMMARY

A printing device of the present disclosure has an aspect of including:
a print head including a first nozzle array in which a plurality of first nozzles configured to
discharge a first liquid onto a medium are arranged in a predetermined nozzle arrangement direction, and a second nozzle array in which a plurality of second nozzles configured to discharge the first liquid onto the medium are arranged in the nozzle arrangement direction,
a transfer unit configured to relatively move the medium in a relative movement direction intersecting the nozzle arrangement direction with reference to the print head, and
a control unit configured to control discharge of a liquid containing the first liquid by the print head, in which
the print head includes an overlapping portion in which a part of the first nozzle array and a part of the second nozzle array overlap as viewed from the relative movement direction,
in the overlapping portion, the first nozzle array is positioned more upstream in the relative movement direction than the second nozzle array,
a boundary between a first print region by the first nozzle array and a second print region by the second nozzle array is within a range of the overlapping portion in the nozzle arrangement direction,
the plurality of first nozzles include a normal nozzle present in the first print region and an anti-flow dot forming nozzle present at an end portion at a side of the first print region in the second print region, and
the control unit causes the print head to form a plurality of anti-flow dots not adjacent to each other in the relative movement direction by the first liquid discharged from the anti-flow dot forming nozzle to the medium during printing.

A printing method of the present disclosure is a printing method of relatively moving a medium in a relative movement direction intersecting a predetermined nozzle arrangement direction with reference to a print head and discharging a liquid containing a first liquid from the print head to the medium, the printing method has an aspect in which
the print head includes a first nozzle array in which a plurality of first nozzles configured to
discharge the first liquid onto the medium are arranged in the nozzle arrangement direction, and a second nozzle array in which a plurality of second nozzles configured to discharge the first liquid onto the medium are arranged in the nozzle arrangement direction,
the print head includes an overlapping portion in which a part of the first nozzle array and a part of the second nozzle array overlap as viewed from the relative movement direction,
in the overlapping portion, the first nozzle array is positioned more upstream in the relative movement direction than the second nozzle array,
a boundary between a first print region by the first nozzle array and a second print region by the second nozzle array is within a range of the overlapping portion in the nozzle arrangement direction,
the plurality of first nozzles include a normal nozzle present in the first print region and an anti-flow dot forming nozzle present at an end portion at a side of the first print region in the second print region, and
when a streak due to a flow of the first liquid is generated between the first print region and the second print region in printing not using the anti-flow dot forming nozzle, a plurality of anti-flow dots not adjacent to each other in the relative movement direction are formed by the first liquid discharged from the anti-flow dot forming nozzle to the medium.

Furthermore, a printing method of the present disclosure is a printing method of relatively moving a medium in a relative movement direction intersecting a predetermined nozzle arrangement direction with reference to a print head and discharging a liquid containing a first liquid from the print head to the medium, the printing method has an aspect in which
the print head includes a first nozzle array in which a plurality of first nozzles configured to
discharge the first liquid onto the medium are arranged in the nozzle arrangement direction, and a second nozzle array in which a plurality of second nozzles configured to discharge the first liquid onto the medium are arranged in the nozzle arrangement direction,
the print head includes an overlapping portion in which a part of the first nozzle array and a part of the second nozzle array overlap as viewed from the relative movement direction,
in the overlapping portion, the first nozzle array is positioned more upstream in the relative movement direction than the second nozzle array,
where n is an integer of 2 or more and a pair of the first nozzle and the second nozzle in which a position in the overlapping portion of the first nozzle array and a position in the overlapping portion of the second nozzle array are in a corresponding relationship is defined as a nozzle pair, the overlapping portion has n sets of the nozzle pairs arranged in the nozzle arrangement direction,
the printing method includes
a first test pattern printing step for, when a first test pattern for determining a use range of the first nozzle and the second nozzle in the overlapping portion is printed on the medium, printing the first test pattern, where m is an integer of 0 or more and less than n, and a number of specific nozzle pairs using the first nozzle and the second nozzle among the nozzle pairs for discharge of the first liquid is m pairs, and
a use range determination step for determining the use range based on a density of a specific region from a first print position to a second print position,
the first print position is a print position of the first nozzle closest to a side of a second print region by the second nozzle array in a first print region by the first nozzle array in the first test pattern printed on the medium,
the second print position is a print position of the second nozzle positioned closest to a side of the first print region in the second print position in the first test pattern printed on the medium,
the plurality of first nozzles include a normal nozzle present in the first print region and an anti-flow dot forming nozzle present at an end portion at the side of the first print region in the second print region, and
the printing method further includes
an anti-flow dot forming step for, when a streak due to a flow of the first liquid is generated between the first print region and the second print region in printing based on the use range, forming a plurality of anti-flow dots not adjacent to each other in the relative movement direction by the first liquid discharged from the anti-flow dot forming nozzle to the medium.

### BRIEF DESCRIPTION OF THE DRAWINGS

FIG. 1 is a block diagram schematically illustrating a configuration example of a printing device.

FIG. 2 is a view schematically illustrating an example of a positional relationship between a print head and a medium.

FIG. 3A is a view schematically illustrating parts of a first nozzle array and a second nozzle array as an example of an ideal state, FIG. 3B is a view schematically illustrating parts of the first nozzle array and the second nozzle array as a first example that is not in an ideal state, and FIG. 3C is a view schematically illustrating parts of the first nozzle array and the second nozzle array as a second example that is not in an ideal state.

FIG. 4 is a flowchart schematically showing an example of nozzle use range determination processing.

FIG. 5A is a view illustrating an overlapping portion and a first test pattern when an adjustment value=0, FIG. 5B is a view illustrating the overlapping portion and the first test pattern when the adjustment value=+1, and FIG. 5C is a view illustrating the overlapping portion and the first test pattern when the adjustment value=−1.

FIG. 6 is a view schematically illustrating a print head and a main part of a print image.

FIG. 7 is a view schematically illustrating an example of an interval between anti-flow dots.

FIG. 8 is a view schematically illustrating an example of a size of the anti-flow dot.

FIG. 9 is a view schematically illustrating an example of the number of anti-flow dot forming nozzles.

FIG. 10 is a flowchart schematically showing an example of adjustment processing.

FIG. 11 is a view schematically illustrating the print head and a main part of a second test pattern.

FIG. 12 is a flowchart schematically showing an example of print control processing.

FIG. 13 is a flowchart schematically showing another example of the print control processing.

FIG. 14 is a view schematically illustrating a behavior example of a first liquid on a medium when the wettability of the liquid to the medium is low.

### DESCRIPTION OF EMBODIMENTS

Hereinafter, an embodiment of the present disclosure will be described. Of course, the following embodiment is merely illustrative of the present disclosure, and not all of the characteristics presented in the embodiment are essential to the solution of the disclosure.

### (1) Summary of Aspect Included in Present Disclosure

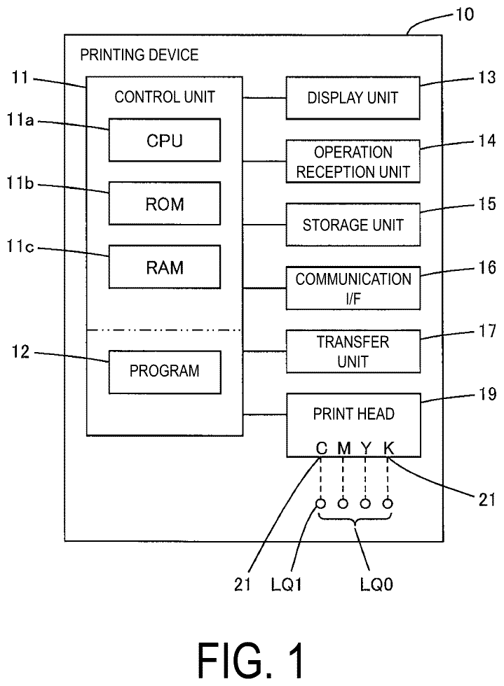

First, an outline of an aspect included in the present disclosure will be described with reference to the examples illustrated in FIGS. 1 to 14. Note that the drawings of the present application schematically illustrate examples, the ratios, shapes, and shades illustrated in these drawings are not necessarily accurate, the drawings are not necessarily consistent, and parts thereof may be omitted. Of course, each element of the present aspect is not limited to a specific example indicated by a reference sign. In “Summary of Aspect Included in Present Disclosure”, what is parenthesized means a supplementary description of the immediately preceding word.

### Aspect 1

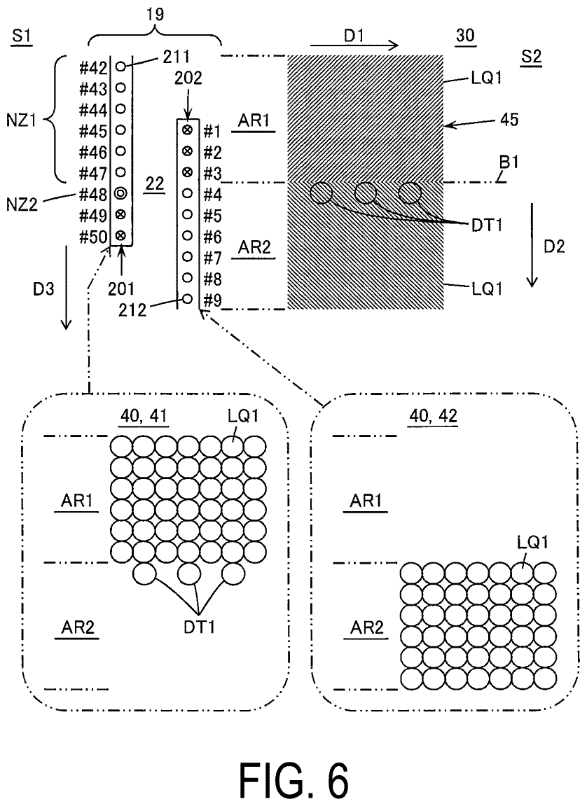

A printing device 10 according to one aspect includes a print head 19, a transfer unit 17, and a control unit 11 as illustrated in FIG. 1 and the like. As illustrated in FIG. 6 and the like, the print head 19 includes a first nozzle array 201 in which a plurality of first nozzles 211 configured to discharge a first liquid LQ1 onto a medium 30 are arranged in a predetermined nozzle arrangement direction D3, and a second nozzle array 202 in which a plurality of second nozzles 212 configured to discharge the first liquid LQ1 onto the medium 30 are arranged in the nozzle arrangement direction D3. The transfer unit 17 relatively moves the medium 30 in a relative movement direction D1 intersecting the nozzle arrangement direction D3 with reference to the print head 19. The control unit 11 controls discharge of a liquid LQ0 containing the first liquid LQ1 by the print head 19. The print head 19 includes an overlapping portion 22 in which a part of the first nozzle array 201 and a part of the second nozzle array 202 overlap as viewed from the relative movement direction D1. In the overlapping portion 22, the first nozzle array 201 is positioned more upstream S1 in the relative movement direction D1 than the second nozzle array 202. In the nozzle arrangement direction D3, a boundary B1 between a first print region AR1 by the first nozzle array 201 and a second print region AR2 by the second nozzle array 202 is within a range of the overlapping portion 22. The plurality of first nozzles 211 include a normal nozzle NZ1 present in the first print region AR1 and an anti-flow dot forming nozzle NZ2 present at an end portion at a side of the first print region AR1 in the second print region AR2. The control unit 11 causes the print head 19 to form a plurality of anti-flow dots DT1 not adjacent to each other in the relative movement direction D1 by the first liquid LQ1 discharged from the anti-flow dot forming nozzle NZ2 to the medium 30 during printing.

A test result shows that when the wettability of the liquid LQ0 to the medium 30 is low, the first liquid LQ1 previously discharged from the first nozzle array 201 flows so as to gather on the medium 30, whereby a light streak along the relative movement direction D1 of the medium 30 is generated between the nozzle arrays. Note that a light streak means a streak in which a ground color component of the medium 30 appears. In the above aspect, since the plurality of anti-flow dots DT1 not adjacent to each other in the relative movement direction D1 with respect to the end portion at the side of the first print region AR1 in the second print region AR2 are formed, the first liquid LQ1 in the first print region AR1 and the first liquid LQ1 in the second print region AR2 appropriately merge. This suppresses a light streak along the relative movement direction D1 between the nozzle arrays configured to discharge the first liquid LQ1. Therefore, the above aspect can provide a printing device configured to suppress a light streak along the relative movement direction of the medium between the nozzle arrays from being generated by the flow of dots on the medium.

The above-described aspect includes various examples.

The transfer unit may move the medium in the relative movement direction without moving the print head, may move the print head in a direction opposite to the relative movement direction without moving the medium, or may move both the medium and the print head.

The upstream in the relative movement direction means not the side to which the medium relatively moves but the side from which the medium relatively moves. Therefore, after the first liquid discharged from the first nozzle array lands at a certain position in the relative movement direction, the first liquid discharged from the second nozzle array lands at the certain position. When the relative movement direction is a conveyance direction of the medium, the medium is conveyed from upstream to downstream.

The anti-flow dot forming nozzle may be one nozzle or two sets or more of nozzles.

The fact that the plurality of anti-flow dots are not adjacent to each other in the relative movement direction means that a plurality of anti-flow dots having a recording rate of 50% or less are formed in units of pixels in the relative movement direction.

The “first”, “second”, and the like in the present application are terms for identifying each constituent element included in a plurality of constituent elements having similarity, and do not mean an order.

Needless to say, the above description also applies to the following aspects.

### Aspect 2

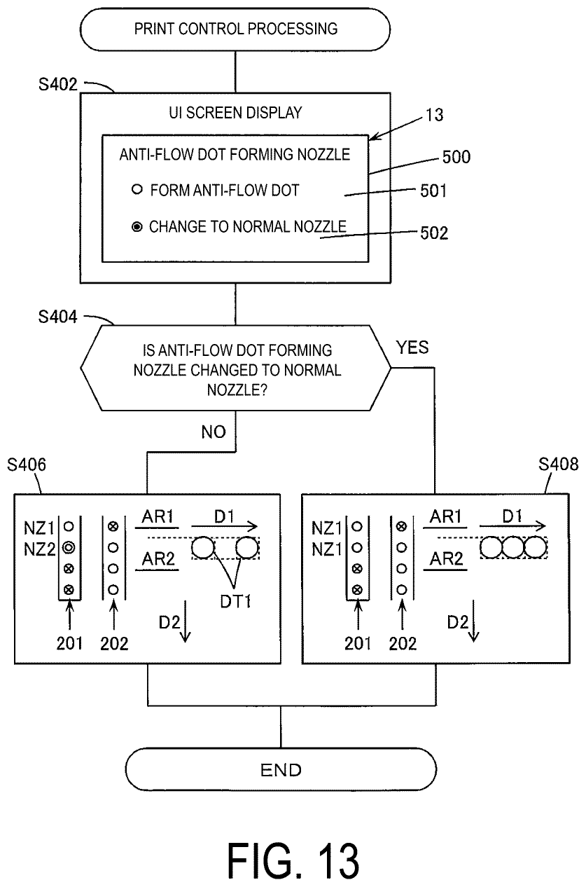

As illustrated in FIGS. 1 and 13, the present printing device 10 may further include an operation reception unit 14 configured to receive a change operation from the anti-flow dot forming nozzle NZ2 to the normal nozzle NZ1. When the change operation is received, the control unit 11 may change the anti-flow dot forming nozzle NZ2 to the normal nozzle NZ1 and control discharge of the liquid LQ0 by the print head 19.

When the anti-flow dot forming nozzle NZ2 is changed to the normal nozzle NZ1, the amount of the first liquid LQ1 discharged from the first nozzle array 201 to the end portion at the side of the first print region AR1 in the second print region AR2 increases. When a light streak is observed even if the anti-flow dot DT1 is formed, if the anti-flow dot forming nozzle NZ2 is changed to the normal nozzle NZ1, the light streak is reduced. Therefore, in the above aspect, the streak along the relative movement direction between the nozzle arrays can be more appropriately suppressed according to the type of the medium or the liquid.

### Aspect 3

As illustrated in FIGS. 1, 8, and 10, the present printing device 10 may further include the operation reception unit 14 configured to receive a setting operation of the size of the anti-flow dot DT1. When the setting operation is received, the control unit 11 may cause the print head 19 to form the plurality of anti-flow dots DT1 with the size.

When the size of the anti-flow dot DT1 increases, the amount of the first liquid LQ1 discharged from the first nozzle array 201 to the end portion at the side of the first print region AR1 in the second print region AR2 increases. When a light streak is observed even if the anti-flow dot DT1 having a relatively small size is formed, if the size of the anti-flow dot DT1 increases, the light streak is reduced. Therefore, in the above aspect, the streak along the relative movement direction between the nozzle arrays can be more appropriately suppressed.

### Aspect 4

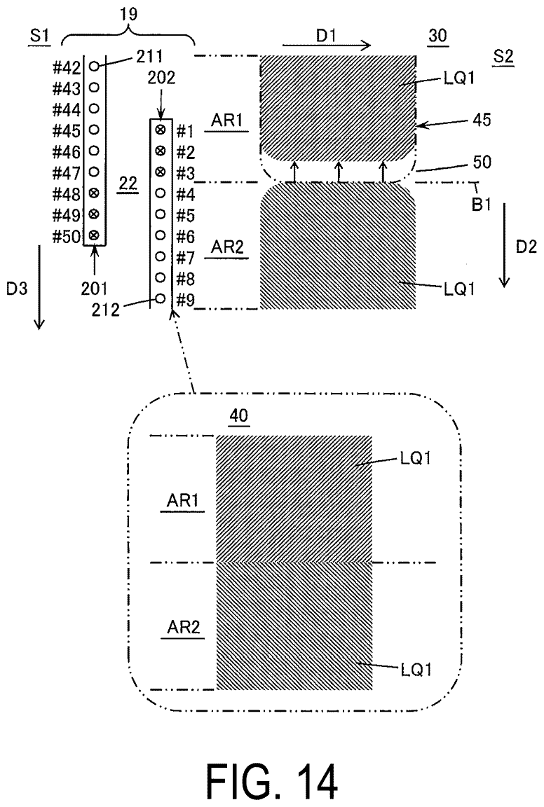

A printing method according to one aspect is a printing method is a printing method of relatively moving the medium 30 in the relative movement direction D1 intersecting the predetermined nozzle arrangement direction D3 with reference to the print head 19 and discharging the liquid LQ0 containing the first liquid LQ1 from the print head 19 to the medium 30. The print head 19 includes the first nozzle array 201 in which the plurality of first nozzles 211 configured to discharge the first liquid LQ1 onto the medium 30 are arranged in the nozzle arrangement direction D3, and the second nozzle array 202 in which the plurality of second nozzles 212 configured to discharge the first liquid LQ1 onto the medium 30 are arranged in the nozzle arrangement direction D3. The print head 19 includes the overlapping portion 22 in which a part of the first nozzle array 201 and a part of the second nozzle array 202 overlap as viewed from the relative movement direction D1. In the overlapping portion 22, the first nozzle array 201 is positioned more upstream S1 in the relative movement direction D1 than the second nozzle array 202. In the nozzle arrangement direction D3, the boundary B1 between the first print region AR1 by the first nozzle array 201 and the second print region AR2 by the second nozzle array 202 is within a range of the overlapping portion 22. The plurality of first nozzles 211 include the normal nozzle NZ1 present in the first print region AR1 and the anti-flow dot forming nozzle NZ2 present at the end portion at the side of the first print region AR1 in the second print region AR2. In the present printing method, as illustrated in FIG. 14, when a streak 50 due to the flow of the first liquid LQ1 is generated between the first print region AR1 and the second print region AR2 in printing not using the anti-flow dot forming nozzle NZ2, the plurality of anti-flow dots DT1 not adjacent to each other in the relative movement direction D1 are formed by the first liquid LQ1 discharged from the anti-flow dot forming nozzle NZ2 onto the medium 30.

The above aspect can provide a printing method configured to suppress a light streak along the relative movement direction of the medium between the nozzle arrays from being generated by the flow of dots on the medium.

### Aspect 5

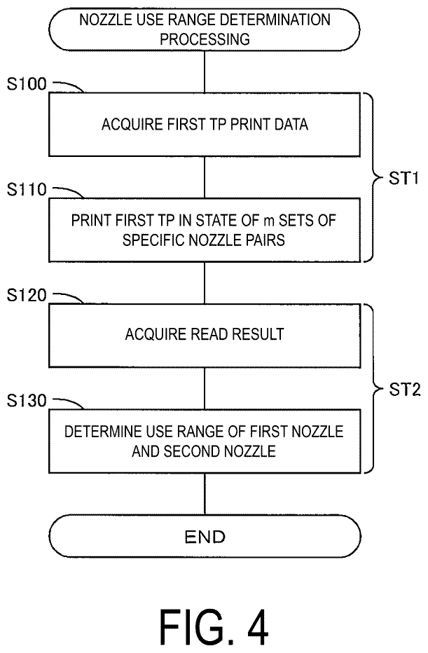

Here, n is an integer of 2 or more and a pair of the first nozzle 201 and the second nozzle 202 in which the position in the overlapping portion 22 of the first nozzle array 211 and the position in the overlapping portion 22 of the second nozzle array 212 are in a corresponding relationship is defined as a nozzle pair. In a printing method according to another aspect, the overlapping portion 22 includes n sets of the nozzle pairs arranged in the nozzle arrangement direction D3. As illustrated in FIG. 4, the present printing method includes the following steps.

(a1) A first test pattern printing step ST1 for, when a first test pattern 31 for determining a use range of the first nozzle 211 and the second nozzle 212 in the overlapping portion 22 is printed on the medium 30, printing the first test pattern 31, where m is an integer of 0 or more and less than n, and the number of specific nozzle pairs using the first nozzle 211 and the second nozzle 212 among the nozzle pairs for discharge of the first liquid LQ1 is m pairs.

(a2) A use range determination step ST2 for determining the use range based on the density of a specific region 32 from the first print position to the second print position.

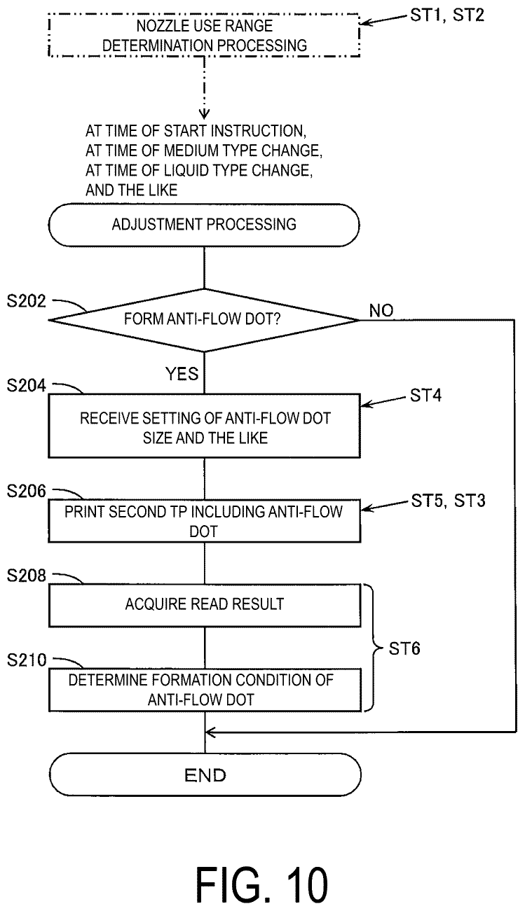

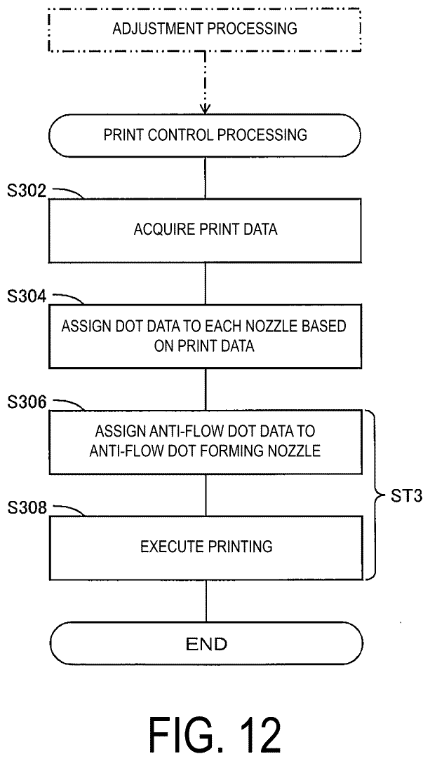

The first print position is a print position of the first nozzle 211 closest to the side of the second print region AR2 by the second nozzle array 201 in the first print region AR1 by the first nozzle array 202 in the first test pattern 31 printed on the medium 30. The second print position is a print position of the second nozzle positioned 212 closest to the side of the first print region AR1 in the second print region AR2 in the first test pattern 31 printed on the medium 30. The plurality of first nozzles 211 include the normal nozzle NZ1 present in the first print region AR1 and the anti-flow dot forming nozzle NZ2 present at the end portion at the side of the first print region AR1 in the second print region AR2. As illustrated in FIGS. 10 and 12, the present printing method further includes the following steps.

(a3) An anti-flow dot forming step ST3 for, when the streak 50 (see FIG. 14) due to a flow of the first liquid LQ1 is generated between the first print region AR1 and the second print region AR2 in printing based on the use range, forming the plurality of anti-flow dots DT1 not adjacent to each other in the relative movement direction D1 by the first liquid LQ1 discharged from the anti-flow dot forming nozzle NZ2 to the medium 30.

A test result shows that even if the use range of the first nozzle 211 and the second nozzle 212 is determined based on the density of the specific region 32 of the first test pattern 31, a light streak along the relative movement direction D1 of the medium 30 is generated between the nozzle arrays when the wettability of the liquid LQ0 to the medium 30 is low. This is because the first liquid LQ1 previously discharged from the first nozzle array 201 flows so as to gather on the medium 30. In the above aspect, when the streak 50 due to a flow of the first liquid LQ1 is generated between the first print region AR1 and the second print region AR2 in printing based on the determined use range, the plurality of anti-flow dots DT1 not adjacent to each other in the relative movement direction D1 with respect to the end portion at the side of the first print region AR1 of the second print region AR2 are formed. By this, the first liquid LQ1 in the first print region AR1 and the first liquid LQ1 in the second print region AR2 appropriately merge, and the light streak along the relative movement direction D1 between the nozzle arrays configured to discharge the first liquid LQ1 is suppressed. Therefore, the above aspect can provide a printing method configured to suppress a light streak along the relative movement direction of the medium between the nozzle arrays from being generated by the flow of dots on the medium.

### Aspect 6

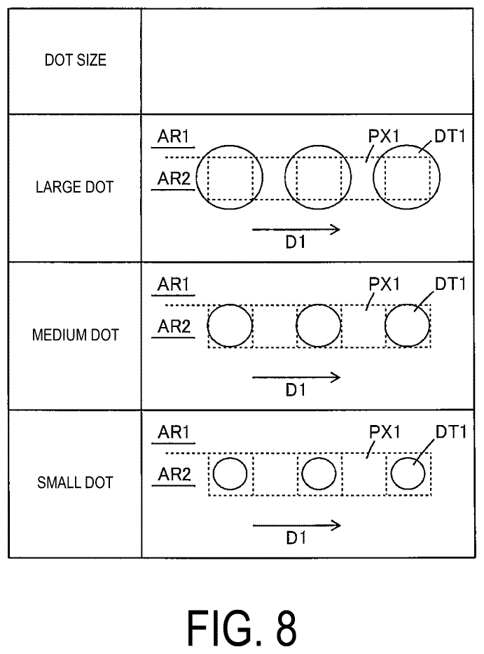

As illustrated in FIGS. 8 and 10, the present printing method may further include the following steps. (a4) A size setting reception step ST4 for receiving setting of the size of the anti-flow dot DT1.

In the anti-flow dot forming step ST3, the plurality of anti-flow dots DT1 may be formed with the size.

When the size of the anti-flow dot DT1 increases, the amount of the first liquid LQ1 discharged from the first nozzle array 201 to the end portion at the side of the first print region AR1 in the second print region AR2 increases. When a light streak is observed even if the anti-flow dot DT1 having a relatively small size is formed, if the size of the anti-flow dot DT1 increases, the light streak is reduced. Therefore, in the above aspect, the streak along the relative movement direction between the nozzle arrays can be more appropriately suppressed.

### Aspect 7

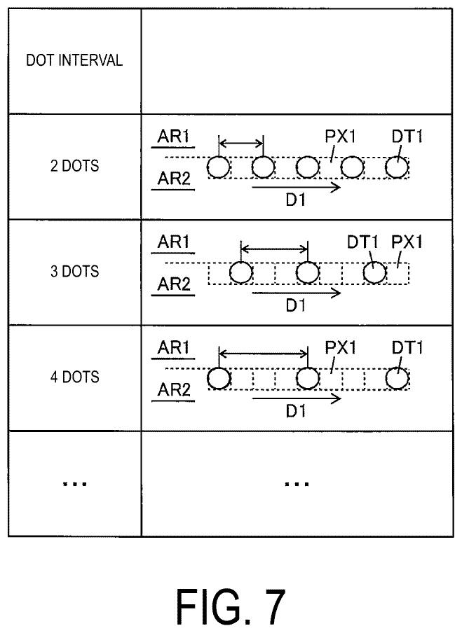

As illustrated in FIGS. 7, 10, and 11, the present printing method may further include the following steps.

(a5) A second test pattern printing step ST5 for forming a second test pattern 35 formed including the anti-flow dot DT1 by the first liquid LQ1 discharged from the first nozzle array 201 and the second nozzle array 202 onto the medium 30, the second test pattern 35 including a plurality of individual patterns 36 in which intervals between the anti-flow dots DT1 in the relative movement direction D1 are varied.

(a6) An interval determination step ST6 for determining the interval between the anti-flow dots DT1 applied to the anti-flow dot forming step ST3 based on the second test pattern 35.

When the interval between the anti-flow dots DT1 is narrowed, the amount of the first liquid LQ1 discharged from the first nozzle array 201 to the end portion at the side of the first print region AR1 in the second print region AR2 increases. When a light streak is observed even if the anti-flow dot DT1 having a relatively wide interval is formed, if the interval between the anti-flow dots DT1 is narrowed, the light streak is reduced. Therefore, in the above aspect, the streak along the relative movement direction between the nozzle arrays can be more appropriately suppressed.

### Aspect 8

In the second test pattern printing step ST5, the second test pattern 35 may be formed when at least one of the type of the medium 30 and the type of the first liquid LQ1 is changed.

The degree to which the dot on the medium 30 flows varies depending on the combination of the type of the medium 30 and the type of the liquid LQ0. By forming the second test pattern 35 by changing at least one of the type of the medium 30 and the type of the first liquid LQ1, it is possible to suitably suppress a light streak along the relative movement direction of the medium between the nozzle arrays from being generated by the flow of dots on the medium.

Furthermore, the above-described aspects can be applied to a multi-function device including the above-described printing device, a control method of the above-described printing device, a control method of the above-described multi-function device, a control program of the above-described printing device, a control program of the multi-function device described above, a computer-readable non-transitory medium recording any of the programs described above, and the like. Any device described above may be constituted by a plurality of separate parts.

### (2) Specific Example of Printing Device

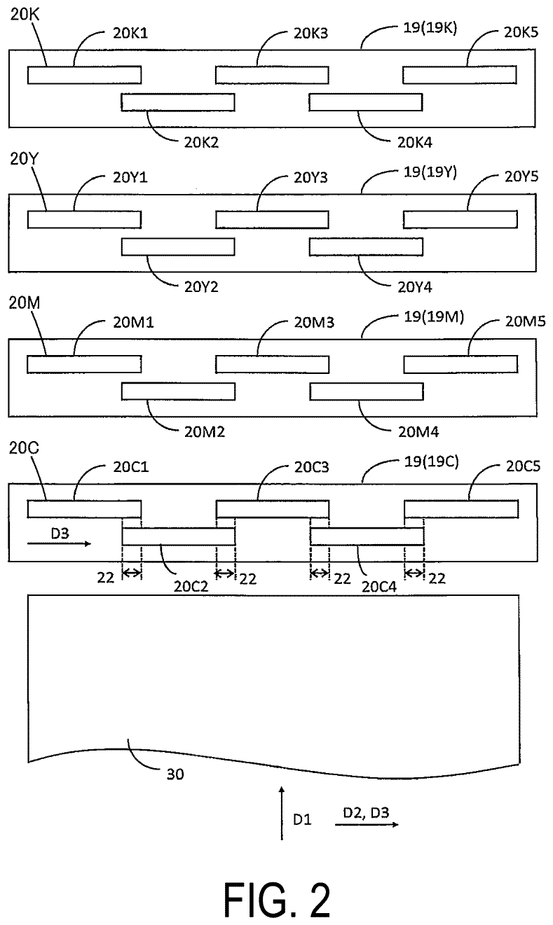

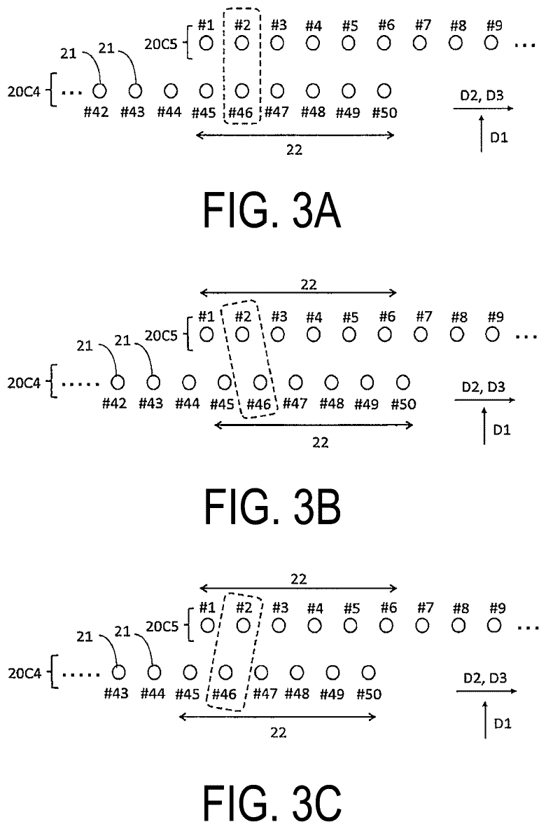

FIG. 1 schematically illustrates the configuration of the printing device 10. A printing method is performed in the printing device 10. FIG. 2 is a plan view briefly illustrating an example of a positional relationship between the print head 19 and the medium 30 from a viewpoint from above. FIGS. 3A to 3C schematically illustrate parts of the first nozzle array and the second nozzle array.

The printing device 10 illustrated in FIG. 1 includes the control unit 11, a display unit 13, the operation reception unit 14, a storage unit 15, a communication interface (I/F) 16, the transfer unit 17, and the print head 19. The control unit 11 includes a central processing unit (CPU) 11a as a processor, a read only memory (ROM) 11b, and a random access memory (RAM) 11c. The control unit 11 may include a nonvolatile memory. The control unit 11 including the CPU 11a may include one or a plurality of integrated circuits (ICs).

The CPU 11a uses the RAM 11c or the like as a work area, and controls the printing device 10 by executing arithmetic processing according to a program 12 recorded in the ROM 11b, another memory, or the like. The processor is not limited to one CPU, and may be a plurality of CPUs or a hardware circuit such as an application specific integrated circuit (ASIC). The CPU and the hardware circuit may perform processing in cooperation.

The display unit 13 is a unit that displays visual information, and may be a liquid crystal display, an organic electroluminescence (EL) display, or the like. The display unit 13 may be configured to include a display and a drive circuit for driving the display.

The operation reception unit 14 is a unit that receives input by the user, and may be a physical button, a touchscreen, a mouse, a keyboard, or the like. The touchscreen may be implemented as one function of the display unit 13. The display unit 13 and the operation reception unit 14 may be called an operation panel of the printing device 10.

The storage unit 15 may be a solid state drive, a hard disk drive, another memory, or the like. A part of the memory included in the control unit 11 may be regarded as the storage unit 15. The storage unit 15 may be regarded as a part of the control unit 11. The display unit 13, the operation reception unit 14, and the storage unit 15 may be peripheral equipment externally attached to the printing device 10.

The communication I/F 16 is a generic term for one or a plurality of I/Fs for the printing device 10 to execute communication with an external device in a wired or wireless manner in accordance with a predetermined communication protocol including a known communication standard. The external device may be a communication device such as a personal computer, a server, a smartphone, and a tablet terminal.

As illustrated in FIG. 2, the transfer unit 17 moves the medium 30 in the relative movement direction D1 intersecting the predetermined nozzle arrangement direction D3. When the printing device 10 is a line type inkjet printer such as a line printer, the medium 30 is continuous in the relative movement direction D1, and the transfer unit 17 continuously conveys the medium 30 in the relative movement direction D1 during printing. Therefore, the relative movement direction D1 in the line type printing device can also be said to be a conveyance direction. It can be said that the transfer unit 17 relatively moves the medium 30 in a predetermined conveyance direction (relative movement direction D1) with reference to the print head 19. The transfer unit 17 includes, for example, a roller configured to rotate to convey the medium 30, and a motor as a power source for rotation. The transfer unit 17 may be a mechanism configured to convey the medium 30 by mounting the medium 30 to a pallet, a belt, a drum, or the like. The medium 30 is, for example, a sheet of paper, but may be any medium that can be a target of printing by the liquid LQ0, and may be a material other than paper, such as a fabric or a film.

The print head 19 is a unit that performs printing by discharging the liquid LQ0 onto the medium 30 by an inkjet method under the control of the control unit 11. The liquid LQ0 is mainly ink, but the print head 19 is also configured to discharge the liquid LQ0 other than ink. The print head 19 is configured to discharge inks of a plurality of colors such as cyan (C), magenta (M), yellow (Y), and black (K). Of course, the ink discharged from the print head 19 is not limited to CMYK ink.

The printing device 10 may be implemented by one printer, but may be implemented by coupling a plurality of devices and pieces of equipment in a communicable manner with one another. When the printing device 10 is a system including a plurality of devices, it includes, for example, an information processing device configured to play a role of the control unit 11 and a printer configured to include the transfer unit 17 and the print head 19 and execute printing under the control of the information processing device. In this case, the information processing device can be regarded as a print control device, an image processing device, or the like.

FIG. 2 illustrates print heads 19C, 19M, 19Y, and 19K as the print heads 19 of the line type printing device. The print heads 19C, 19M, 19Y, and 19K of the line type are arranged in order of the relative movement direction D1 and are fixed at a conveyance path of the medium 30. A width direction D2 of the medium 30 intersects the relative movement direction D1. In FIG. 2, the intersection between the relative movement direction D1 and the width direction D2 may be understood to be orthogonal or substantially orthogonal. The nozzle arrangement direction D3 illustrated in FIG. 2 is aligned with the width direction D2. The transfer unit 17 conveys the medium 30 from upstream to downstream in the relative movement direction D1. Hereinafter, the upstream in the relative movement direction D1 may be simply called upstream, and the downstream in the relative movement direction D1 may be simply called downstream. Since the relative movement direction D1 illustrated in FIG. 2 is an upward direction, the lower side is upstream and the upper side is downstream in FIG. 2. Note that in FIG. 6 and the like described later, the left side is the upstream S1, and the right side is downstream S2.

Each of the print heads 19C, 19M, 19Y, and 19K includes a plurality of nozzle arrays. The print head 19C includes a plurality of nozzle arrays 20C configured to discharge C ink. The plurality of nozzle arrays 20C include nozzle arrays 20C1, 20C2, 20C3, 20C4, and 20C5. The print head 19M includes a plurality of nozzle arrays 20M configured to discharge M ink. The plurality of nozzle arrays 20M include nozzle arrays 20M1, 20M2, 20M3, 20M4, and 20M5. The print head 19Y includes a plurality of nozzle arrays 20Y configured to discharge Y ink. The plurality of nozzle arrays 20Y include nozzle arrays 20Y1, 20Y2, 20Y3, 20Y4, and 20Y5. The print head 19K includes a plurality of nozzle arrays 20K configured to discharge K ink. The plurality of nozzle arrays 20K include nozzle arrays 20K1, 20K2, 20K3, 20K4, and 20K5. Of course, the number of nozzle arrays constituting the print head 19 corresponding to one type of liquid LQ0 needs not be 5.

Each of the print heads 19C, 19M, 19Y, and 19K has a length in the width direction D2 that can cover the medium width, which is the length of the medium 30 in the width direction D2. The configurations of the print heads 19C, 19M, 19Y, and 19K are basically the same except for the colors of the ink to be discharged, and hence description is made at the print head 19C as a representative example. In all of the nozzle arrays 20C1, 20C2, 20C3, 20C4, and 20C5 constituting the print head 19C, the plurality of nozzles 21 configured to discharge the C ink as the first liquid LQ1 (see FIG. 1) that is the same liquid LQ0 are arranged in the nozzle arrangement direction D3. When attention is paid to the print head 19M, the M ink is put into the first liquid LQ1. When the liquid LQ0 discharged by a certain print head 19 is called the first liquid LQ1 by paying attention to the print head 19, the liquid LQ0 discharged by another print head 19 may be called a second liquid.

In FIG. 2, a chip including each nozzle array is indicated by a simple rectangle, and the description of each nozzle 21 included in the nozzle array is omitted. As illustrated in FIG. 2, the print head 19 includes a plurality of chips arranged in a staggered manner so as to be continuous in the width direction D3, and each chip includes a nozzle array. For example, the print head 19C includes a chip including the nozzle array 20C1, a chip including the nozzle array 20C2, a chip including the nozzle array 20C3, a chip including the nozzle array 20C4, and a chip including the nozzle array 20C5. Note that each chip may include a plurality of nozzle arrays in CMYK. Incorporation of a plurality of chips into the print head 19 can cause an attachment error between the chips. In FIG. 3A and the like, the individual nozzles 21 are indicated by circles. The plurality of nozzles 21 in the nozzle array may be arranged in one row, or may be arranged in a staggered manner, that is, two rows. Here, the nozzle arrangement direction D3 of the plurality of nozzles 21 arranged in a staggered manner is a direction of arrangement of the nozzles 21 focusing on each row of the two rows. The interval between the nozzles 21 adjacent to each other in the nozzle array, that is, the distance between the nozzles 21 in the nozzle arrangement direction D3 is called a nozzle pitch. The nozzle pitch is constant in design. The nozzle arrangement direction D3 may be parallel to the width direction D2 or may be inclined obliquely with respect to the width direction D2. In any case, the nozzle arrangement direction D3 intersects the relative movement direction D1. An interval between the nozzles 21 in the width direction D2 may be regarded as a nozzle pitch.

In the present specific example, of two nozzle arrays adjacent to each other in the relative movement direction D1 in one print head 19, the nozzle array at the upstream is called a “first nozzle array”, and the nozzle array at the downstream is called a “second nozzle array” for distinction. In the “first nozzle array”, a plurality of “first nozzles” configured to discharge the first liquid LQ1 onto the medium 30 are arranged in the nozzle arrangement direction D3. In the “second nozzle array”, a plurality of “second nozzles” configured to discharge the first liquid LQ1 onto the medium 30 are arranged in the nozzle arrangement direction D3. The terms “first nozzle array” and “second nozzle array” are merely for convenience of distinction when attention is paid to certain two nozzle arrays. For example, attention is paid to the nozzle arrays 20C1 and 20C2 in the print head 19C, when the nozzle array 20C2 at the upstream is put into the first nozzle array, the nozzle array 20C1 at the downstream is put into the second nozzle array. In this case, it can be said that the plurality of first nozzles configured to discharge the C ink are arranged in the nozzle arrangement direction D3 in the nozzle array 20C2, and the plurality of second nozzles configured to discharge the C ink are arranged in the nozzle arrangement direction D3 in the nozzle array 20C1. Similarly, attention is paid to the nozzle arrays 20C4 and 20C5, when the nozzle array 20C4 at the upstream is put into the first nozzle array, the nozzle array 20C5 at the downstream is put into the second nozzle array. In this case, it can be said that the plurality of first nozzles configured to discharge the C ink are arranged in the nozzle arrangement direction D3 in the nozzle array 20C4, and the plurality of second nozzles configured to discharge the C ink are arranged in the nozzle arrangement direction D3 in the nozzle array 20C5. The control unit 11 controls discharge of the liquid LQ0 containing the first liquid LQ1 by the print head 19 in this manner.

In the present specific example, in the plurality of nozzle arrays constituting one print head 19, the end portions of the nozzle arrays adjacent to each other overlap in the nozzle arrangement direction D3. Therefore, the print head 19 can be said to include the “overlapping portion 22” in which a part of the first nozzle array and a part of the second nozzle array overlap as viewed from the relative movement direction D1. FIG. 2 illustrates the range of each overlapping portion 22 included in the print head 19C. In the overlapping portion 22, the first nozzle array is positioned more upstream in the relative movement direction D3 than the second nozzle array. Note that of the range in which the nozzles 21 included in the print head 19 are arranged, a range not falling into the overlapping portion 22 is called a “normal portion”.

In the present specific example, a pair of the first nozzle and the second nozzle in which the position in the overlapping portion 22 of the first nozzle array and the position in the overlapping portion 22 of the second nozzle array are in a corresponding relationship is called a “nozzle pair”. One overlapping portion 22 includes n sets of nozzle pairs arranged in the nozzle arrangement direction D3. n is an integer of 2 or more, for example, n=64. Here, right and left when viewed from a viewpoint facing from upstream to downstream are simply called right and left, respectively. The first nozzle and the second nozzle in which the position in the overlapping portion 22 of the first nozzle array and the position in the overlapping portion 22 of the second nozzle array are in a corresponding relationship refer to the first nozzle and the second nozzle in which the order in the left-right direction in the overlapping portion 22 coincides. For example, in the overlapping portion 22 between the nozzle array 20C4 and the nozzle array 20C5, the nozzle 21 leftmost in the nozzle array 20C4 and the nozzle 21 leftmost in the nozzle array 20C5 form one set of nozzle pair. In a similar manner, in the overlapping portion 22 between the nozzle array 20C4 and the nozzle array 20C5, the nozzle 21 second from the left in the nozzle array 20C4 and the nozzle 21 second from the left in the nozzle array 20C5 form one set of nozzle pair.

The control unit 11 causes the print head 19 to discharge the liquid LQ0 as a droplet onto the medium 30 based on print data expressing an image. As is known, the print head 19 is provided with a drive element for each nozzle 21, and application of a drive signal to the drive element of each nozzle 21 is controlled according to print data, whereby each nozzle 21 discharges a droplet or does not discharge a droplet. When the droplet from the nozzles 21 lands on the medium 30, a dot is formed on the medium 30. By this, an image expressed by the print data is printed on the medium 30 as a dot pattern. Here, the print data is assumed to be data indicating a discharge state of a droplet, for example, the presence or absence of discharge, for each pixel and each CMYK. In this case, the print data can also be said to be image data indicating a dot formation state, for example, the presence or absence of formation, for each pixel and each CMYK. Discharge of a droplet can be said to be dot-on, and non-discharge of a droplet can be said to be dot-off. The control unit 11 controls the transfer unit 17 and the print head 19 to discharge a droplet such as an ink droplet onto the medium 30 passing under the print heads 19C, 19M, 19Y, and 19K, thereby performing control to form a print image onto the medium 30.

FIG. 3A schematically illustrates the overlapping portion 22 and the vicinity thereof in an enlarged manner as an example of an ideal state. The ideal state means a state in which there is no or few errors in the positional relationship in the nozzle arrangement direction D3 between the first nozzle array and the second nozzle array sharing the overlapping portion 22. Note that in FIGS. 3A to 3C, the nozzle arrangement direction D3 and the width direction D2 are parallel to each other. Here, the nozzle array 20C4 of the print head 19C is assumed to be the first nozzle array, and the nozzle array 20C5 is assumed to be the second nozzle array.

In FIGS. 3A to 3C, for convenience, the nozzles 21 constituting one nozzle array are assigned with nozzle numbers in order from left to right along the nozzle arrangement direction D3. Note that the nozzle 21 with the nozzle number #(numeral) is also simply described as the nozzle #(numeral). In the example illustrated in FIG. 3A, each nozzle array includes 50 nozzles 21, and the range of six consecutive nozzles #45 to #50 of the nozzle array 20C4 and the range of six consecutive nozzles #1 to #6 of the nozzle array 20C5 form the overlapping portion 22. That is, in the example of FIG. 3A, n=6. According to the example of FIG. 3A, the range of 38 consecutive nozzles #7 to #44 in each nozzle array corresponds to the normal portion. In FIG. 3A, the nozzle 21 with the nozzle number #46 in the nozzle array 20C4 and the nozzle 21 with the nozzle number #2 in the nozzle array 20C5 are surrounded by the broken line to indicate those are one set of nozzle pair in the overlapping portion 22.

In FIG. 3A, the first nozzle and the second nozzle forming a nozzle pair, for example, the nozzle 21 with the nozzle number #46 of the nozzle array 20C4 and the nozzle 21 with the nozzle number #2 of the nozzle array 20C5 coincide in position in the width direction D2. Therefore, in the ideal state, the first nozzle and the second nozzle forming the nozzle pair are configured to discharge droplets of the same color to the same position of the medium 30. However, an actual product has an individual difference, and such an ideal state is not necessarily achieved.

FIGS. 3B and 3C schematically illustrate the overlapping portion 22 and the vicinity thereof in an enlarged manner as an example of not an ideal state. In FIGS. 3B and 3C, the same description as that of FIG. 3A is omitted. In the example illustrated in FIG. 3B, in the nozzle arrangement direction D3, the nozzle array 20C4 and the nozzle array 20C5 are in a positional relationship where they are closer to each other than in the ideal state of FIG. 3A. In the example illustrated in FIG. 3C, in the nozzle arrangement direction D3, the nozzle array 20C4 and the nozzle array 20C5 are in a positional relationship where they are farther from each other than in the ideal state of FIG. 3A. Therefore, in FIGS. 3B and 3C, the nozzle #46 of the nozzle array 20C4 and the nozzle #2 of the nozzle array 20C5 forming the nozzle pair are misaligned from each other when viewed from the relative movement direction D1.

When the print head 19 alternately including the normal portion and the overlapping portion 22 is used for printing, ink in one color of one raster line is printed by one nozzle 21 by the normal portion, and ink in one color of one raster line is printed by one set of nozzle pairs by the overlapping portion 22. The raster line is a linear image in which the longitudinal direction is oriented in the relative movement direction D1, and is a pixel row in which pixels are arranged along the relative movement direction D1 in the print data. Printing ink in one color of one raster line with one set of nozzle pairs is also called overlap (OL) printing. In the OL printing, each of the two nozzles 21 forming one set of nozzle pair is used by a usage ratio of 50%, for example.

In a print result reproduced on the medium 30, a density difference easily occurs between a region formed by each raster line printed by the normal portion and a region formed by each raster line OL printed by the respective nozzle pair in the overlapping portion 22. This is because the number of nozzles used for printing per one raster line is different between each raster line printed by the normal portion and each raster line OL printed by the overlapping portion 22. Such a difference affects each element such as ink bleed, drying, and line thickness, resulting in generation of a density difference. Such a density difference is recognized by the user as density unevenness.

In the nozzle arrangement direction D3, the boundary B1 (see FIG. 6) between the first print region AR1 by the first nozzle array and the second print region AR2 by the second nozzle array is within a range of the overlapping portion 22. In the present specific example, in order to minimize the density difference between the print result by the normal portion and the print result by the overlapping portion 22 as much as possible, OL printing is performed in the overlapping portion 22 as little as possible. This can be said to avoid using all the n sets of nozzle pairs for OL printing. However, it is necessary to avoid generating a gap in the width direction D2 between the first print region AR1 by the first nozzle array and the second print region AR2 by the second nozzle array due to not performing OL printing. Therefore, first, the use range of the first nozzle and the second nozzle are determined according to the first test pattern without the anti-flow dots. Hereinafter, the test pattern may be abbreviated as TP, and the first test pattern may be abbreviated as first TP.

FIG. 4 schematically shows, with a flowchart, nozzle use range determination processing performed by the control unit 11 according to the program 12. Here, steps S100 to S110 correspond to the first test pattern printing step ST1, and steps S120 to S130 correspond to the use range determination step ST2. Hereinafter, description of “step” may be omitted and a step sign may be shown in parentheses. The nozzle use range determination processing starts when the control unit 110 receives a start instruction for the nozzle use range determination processing via the operation reception unit 14.

When the nozzle use range determination processing is started, the control unit 11 acquires first TP print data, which is print data expressing the first TP (S100). When the first TP print data is stored in a storage location such as the storage unit 15, a memory inside and outside the printing device 10, or the like, the control unit 11 can acquire the first TP print data from the storage location. The control unit 11 may acquire the first TP print data by receiving the first TP print data from an external device via the communication I/F 16. Of course, the control unit 11 may generate the first TP print data by acquiring image data of the first TP from the storage location or the external device and performing image processing such as resolution conversion processing, color conversion processing, halftone processing, and the like for this image data. The processing of generating the first TP print data in this manner is also included in acquiring the first TP print data.

The present specific example assumes that the print data provided by the control unit 11 to the print head 19 is provided after being applied with shift correction between colors, regardless of the TP print data or the print data expressing the image desired by the user. Here, the shift correction between colors will be briefly described. For example, errors may occur in respective attachment positions in the width direction D2 of the print heads 19C, 19M, 19Y, and 19K illustrated in FIG. 2. In this case, with reference to the image of the K ink printed by the print head 19K, misalignment amounts in the width direction D2 of the image of the C ink, the image of the M ink, and the image of the Y ink printed by the print heads 19C, 19M, and 19Y, respectively, are acquired. Then, the shift correction is applied to the print data provided to the print heads 19C, 19M, and 19Y so as to eliminate the misalignment amounts of CMY, respectively, with respect to K in the width direction D2, and a print result in which the misalignment between the colors of CMYK is compensated for in the medium 30 is obtained. In the print data applied with the shift correction between colors, it is determined the raster line of each color of CMYK is assigned to the nozzle 21 of which position of which nozzle array of which print head 19.

After acquiring the first TP print data, the control unit 11 starts conveyance of the medium 30 by the transfer unit 17, and controls the print head 19 based on the first TP print data to print, onto the medium 30, the first TP for determining the use range of the first nozzle and the second nozzle in the overlapping portion 22 (S110). At this time, the control unit 11 causes the TP to be printed with the number of “specific nozzle pairs”, in which the first nozzle and the second nozzle are used for discharge of the first liquid LQ1, among the nozzle pairs in the overlapping portion 22 as m sets. Here, 0≤m<n.

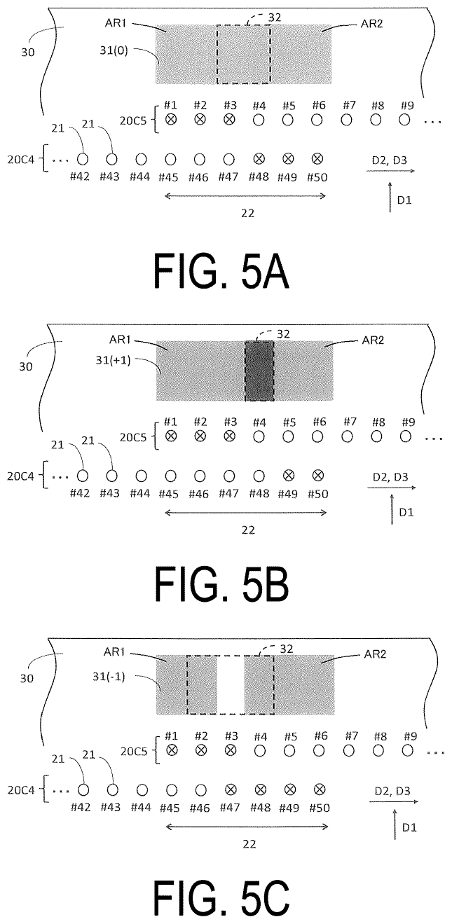

FIGS. 5A to 5C schematically illustrate parts of the first nozzle array and the second nozzle array in the ideal state in the print head 19C, and a first TP 31 printed in S110.

First, description in common to FIGS. 5A to 5C will be given. The first TP 31, which is a print result, is a plain image with ink in one color, and is printed using the C ink in FIGS. 5A to 5C. The first TP 31 illustrated in FIGS. 5A to 5C is printed not by the normal portion but by the overlapping portion 22. However, the first TP 31 may include a region printed by the normal portion in addition to the region printed by the overlapping portion 22. In FIGS. 5A to 5C, numerical values of 0, +1, −1, and the like written in parentheses next to the reference sign 31 mean adjustment values of the use ranges of the first nozzle and the second nozzle adopted by the control unit 11 when the first TP 31 is printed. In FIGS. 5A to 5C, among the nozzles 21 in the overlapping portion 22, the “used nozzle” that discharged the ink for the printing of the first TP 31 is indicated by a simple circle, and the “non-used nozzle” that did not discharge the ink for the printing of the first TP 31 is indicated by a cross (x) mark in the circle.

As illustrated in FIG. 5A, the first TP 31(0) corresponding to the adjustment value=0 is printed, in the overlapping portion 22, with the nozzle numbers #45 to #47 of the nozzle array 20C4 as used nozzles, the nozzle numbers #48 to #50 as non-used nozzles, the nozzle numbers #1 to #3 of the nozzle array 20C5 as non-used nozzles, and the nozzle numbers #4 to #6 as used nozzles. At the time of printing of the first TP 31(0), there are 0 sets of specific nozzle pairs, that is, m=0. Therefore, the first TP 31(0) does not include an OL printed raster line. In this manner, in the ideal state as illustrated in FIG. 5A, when the adjustment value=0, it can be said that printing by the overlapping portion 22 is substantially the same as printing by the normal portion.

As illustrated in FIG. 5B, the first TP 31(+1) corresponding to the adjustment value=+1 is printed, in the overlapping portion 22, with the nozzle numbers #45 to #48 of the nozzle array 20C4 as used nozzles, the nozzle numbers #49 and #50 as non-used nozzles, the nozzle numbers #1 to #3 of the nozzle array 20C5 as non-used nozzles, and the nozzle numbers #4 to #6 as used nozzles. At the time of printing of the first TP 31(+1), there is one set of specific nozzle pair, that is, m=1. According to FIG. 5B, the nozzle #48 of the nozzle array 20C4 and the nozzle #4 of the nozzle array 20C5 correspond to a specific nozzle pair, and the first TP 31(+1) includes a raster line OL-printed by this specific nozzle pair.

Note that in general OL printing, data of a plurality of pixels constituting one raster line to be printed by a nozzle pair is assigned by substantially 50% to each of two nozzles forming the nozzle pair. On the other hand, in the TP printing by step S110, the control unit 11 assigns 100% of data of a plurality of pixels constituting one raster line to be printed by a specific nozzle pair to each of the first nozzle and the second nozzle forming the specific nozzle pair. Therefore, in the example of FIG. 5B, the same raster line is printed in an overlapping manner by each of the nozzle #48 of the nozzle array 20C4 and the nozzle #4 of the nozzle array 20C5.

As illustrated in FIG. 5C, the first TP 31(−1) corresponding to the adjustment value=−1 is printed, in the overlapping portion 22, with the nozzle numbers #45 and #46 of the nozzle array 20C4 as used nozzles, the nozzle numbers #47 to #50 as non-used nozzles, the nozzle numbers #1 to #3 of the nozzle array 20C5 as non-used nozzles, and the nozzle numbers #4 to #6 as used nozzles. At the time of printing of the first TP 31(−1), m=0 similarly to the first TP 31(0), and the OL-printed raster line is not included in the first TP 31(−1). Furthermore, the fact that the adjustment value is negative means that there is an “non-used nozzle pair”, which is a nozzle pair in which both the first nozzle and the second nozzle are non-used nozzles, and when the adjustment value=−1, there is one set of non-used nozzle pair. According to FIG. 5C, the nozzle #47 of the nozzle array 20C4 and the nozzle #3 of the nozzle array 20C5 correspond to the non-used nozzle pair. When the non-used nozzle pair exists, a raster line corresponding to the position of the non-used nozzle pair is not printed among the respective raster lines in the printing data.

In S110, the control unit 11 controls the print head 19 to print, onto the medium 30, the plurality of first TPs 31 having different adjustment values such as the first TP 31(0), the first TP 31(+1), and the first TP 31(−1). Although not illustrated, by controlling the print head 19, the control unit 11 may further print the first TP 31(+2) with the adjustment value=+2 and the first TP 31(−2) with the adjustment value=−2. When the adjustment value=+2, m=2, and in addition to the nozzle pair of the nozzle #48 of the nozzle array 20C4 and the nozzle #4 of the nozzle array 20C5, the nozzle pair of the nozzle #49 of the nozzle array 20C4 and the nozzle #5 of the nozzle array 20C5 is also a specific nozzle pair. On the other hand, when the adjustment value=−2, m=0, and in addition to the nozzle pair of the nozzle #47 of the nozzle array 20C4 and the nozzle #3 of the nozzle array 20C5, the nozzle pair of the nozzle #46 of the nozzle array 20C4 and the nozzle #2 of the nozzle array 20C5 is also a non-used nozzle pair. When two sets or more of specific nozzle pairs are generated in the overlapping portion 22, the control unit 11 generates them so that the plurality of specific nozzle pairs are continuous in the nozzle arrangement direction D3. Similarly, when two sets or more of non-used nozzle pairs are generated in the overlapping portion 22, the control unit 11 generates them so that the plurality of non-used nozzle pairs are continuous in the nozzle arrangement direction D3.

After printing the first TP, the control unit 11 acquires a read result of the first TP 31 on the medium 30 (S120). When the user visually evaluates the first TP 31, the control unit 11 may acquire, as a read result, a result selected from the first TP 31(0), the first TP 31(+1), the first TP 31(−1), and the like via the operation reception unit 14. Here, in the first TP 31, the print region by the first nozzle array is called the first print region AR1, and the print region by the second nozzle array is called the second print region AR2. At the first TP 31, the user evaluates the density of the “specific region 32” from the “first print position” of the print position by the first nozzle closest to the side of the second print region AR2 of the first print region AR1 to the “second print position” of the print position by the second nozzle closest to the side of the first print region AR1 of the second print region AR2. FIGS. 5A to 5C indicate that the specific region 32 of the first TP 31 is surrounded by the broken line. Note that a mark such as a broken line indicating the specific region 32 in an easy-to-understand manner may be printed together with the first TP 31 in S110, or needs not be printed.

For the first TP 31(0), the print position by the nozzle #47 is closest to the side of the second print region AR2 by the nozzle array 20C5 of the first print region AR1 by the nozzle array 20C4. Therefore, the print position by the nozzle #47 corresponds to the first print position. In the second print region AR2 by the nozzle array 20C5, the print position by the nozzle #4 is closest to the side of the first print region AR1 by the nozzle array 20C4. Therefore, the print position by the nozzle #4 corresponds to the second print position. Therefore, in the first TP 31(0), the region from the first print position by the nozzle #47 of the nozzle array 20C4 to the second print position by the nozzle #4 of the nozzle array 20C5 in the width direction D2 corresponds to the specific region 32.

For the first TP 31(+1), the print position on the medium 30 by the nozzle #48 of the nozzle array 20C4 corresponds to the first print position, and the print position on the medium 30 by the nozzle #4 of the nozzle array 20C5 corresponds to the second print position. Therefore, in the first TP 31(+1), a region in the width direction D2 from the first print position by the nozzle #48 of the nozzle array 20C4 to the second print position by the nozzle #4 of the nozzle array 20C5 corresponds to the specific region 32. As illustrated in FIG. 5B, in the ideal state, since the first print position and the second print position are the same, the specific region 32 is a region for one raster line.

For the first TP 31(−1), the print position on the medium 30 by the nozzle #46 of the nozzle array 20C4 corresponds to the first print position, and the print position on the medium 30 by the nozzle #4 of the nozzle array 20C5 corresponds to the second print position. Therefore, in the first TP 31(−1), a region in the width direction D2 from the first print position by the nozzle #46 of the nozzle array 20C4 to the second print position by the nozzle #4 of the nozzle array 20C5 corresponds to the specific region 32.

When the above-described adjustment value increases, a raster line OL printed by the specific nozzle pair is generated at the first TP 31, and therefore a “black streak” as illustrated in FIG. 5B is likely to occur in the specific region 32. The black streak means a “dark streak” higher in density than a nearby color in the first TP 31, that is, streak-like unevenness of a dark color, and is not necessarily black. Conversely, when the adjustment value decreases, since the first TP 31 is printed by the overlapping portion 22 including the non-used nozzle pair, a “white streak” as illustrated in FIG. 5C is likely to occur in the specific region 32. The white streak means a “light streak” lower in density than a nearby color in the first TP 31, that is, streak-like unevenness of a bright color, and is not necessarily white. The white streak means a light streak in which a ground color component of the medium 30 appears. However, an adjustment value at which no streak is generated, an adjustment value at which a black streak is generated, and an adjustment value at which a white streak is generated are different depending on an error in position between the nozzle arrays in the width direction D2 or the like. Therefore, the control unit 11 performs processing of acquiring the read result via the operation reception unit 14. At this time, the user can notify the control unit 11 of a selection result by visually evaluating the plurality of first TPs 31 on the medium 30, selecting the first TP 31 having the best image quality, and operating the operation reception unit 14. Good image quality indicates that a white streak or a black streak is not noticeable. Even if the user does not clearly recognize the specific region 32 in the first TP 31, as a result, the first TP 31 in which the black streak or the white streak is strongly generated in the specific region 32 is not selected, and the first TP 31 in which the black streak or the white streak is not generated or hardly noticeable in the specific region 32 is selected. Therefore, it can be interpreted that the user reads the specific region 32.

Identification information such as a number, a name, and an adjustment value may be printed together at each of the first TPs 31 having different adjustment values so that the user can easily select the first TP 31. The user may input the identification information of the selected first TP 31 through the operation reception unit 14 to notify the control unit 11 of the identification information. The processing of acquiring the selection result of the first TP 31 from the user corresponds to the acquisition of the read result of the first TP 31 in S120. The first TP 31 may be not visually read by the user by read by a reading device not illustrated such as a scanner or a colorimeter, and read image data and colorimetric values as a read result may be transmitted from the reading device to the printing device 10 through the communication I/F 16. That is, in S120, the control unit 11 may acquire the read result of first TP 31 from the reading device.

After acquiring the read result, the control unit 11 determines the use range of the first nozzle and the use range of the second nozzle according to the read result (S130). When acquiring the selection result of the first TP 31 from the user, the control unit 11 determines the use range adopted during printing of the first TP 31 selected by the user. For example, if the first TP 31(+1) is selected by the user, as illustrated in FIG. 5B, the control unit 11 determines the range of the nozzle numbers #45 to #48 of the nozzle array 20C4 in the overlapping portion 22 to be the use range of the first nozzle in the overlapping portion 22, and determines the range of the nozzle numbers #4 to #6 of the nozzle array 20C5 in the overlapping portion 22 to be the use range of the second nozzle in the overlapping portion 22. In this case, there is one set of specific nozzle pair to be used for OL printing in the overlapping portion 22. When acquiring the read image data and the colorimetric value as a read result of the first TP 31 from the reading device, the control unit 11 may analyze the read result of each first TP 31, evaluate the presence or absence and the degree of the black streak and the white streak in the specific region 32 based on a predetermined evaluation criterion, and select the first TP 31 having the best image quality. That is, the control unit 11 may execute, according to the program 12, selection of the first TP 31 performed by the user as described above. Then, regarding the overlapping portion 22, the control unit 11 determines the use range of the first nozzle and the use range of the second nozzle as the use range adopted during printing of the selected first TP 31. In this manner, in S120 and S130, the control unit 11 determines the use range of the first nozzle and the use range of the second nozzle based on the density of the specific region 32 of the first TP 31 printed on the medium 30.

In the examples of FIGS. 5A to 5C, the use range of the nozzles 21 of the nozzle array 20C5 as the second nozzle array is fixed regardless of the adjustment value, and the use range of the nozzles 21 of the nozzle array 20C4 as the first nozzle array varies depending on the adjustment value in the overlapping portion 22. Of course, when printing the first TP 31, the control unit 11 may fix the use range of the nozzle 21 of the first nozzle array and vary the use range of the nozzle 21 of the second nozzle array depending on the adjustment value. In this manner, when only the use range of the nozzle 21 of one nozzle array of the first nozzle array and the second nozzle array is varied in the overlapping portion 22, the use range of the first nozzle and the second nozzle are determined by determining the use range of the nozzle 21 of the nozzle array whose use range is variable. Of course, when printing the first TP 31, the control unit 11 may vary, depending on the adjustment value, the use range of the nozzle 21 of the first nozzle array and the use range of the nozzle 21 of the second nozzle array.

After determining the use range of the first nozzle and the second nozzle, the control unit 11 saves the determination content thereof, and ends the nozzle use range determination processing shown in FIG. 4. To determine the use range is also to determine a non-use range of the nozzle 21 at the same time. All the nozzles 21 are in the use range regarding the normal portion, and hence there is no need to newly determine the use range and the non-use range. The control unit 11 performs the nozzle use range determination processing shown in FIG. 4 for all of the overlapping portions 22 of the print heads 19C, 19M, 19Y, and 19K, and determines the use range of the first nozzle and the second nozzle for each overlapping portion 22.

Thereafter, when executing printing in response to a user's instruction, the control unit 11 performs printing by adopting the range determined as described above as the use range of the first nozzle and the second nozzle in the overlapping portion 22.

As described above, for the combination of the medium 30 and the liquid LQ0 used for printing, it is possible to reduce, as much as possible, the number of specific nozzle pairs to be OL printed in the overlapping portion 22, and it is possible to suppress density unevenness such as a black streak or a white streak from occurring in the print result by the overlapping portion 22 and the image quality from deteriorating. As a result, a problem that a density difference between the region printed by the normal portion and the region OL printed by the overlapping portion 22 is noticeable can also be solved.

However, it is found that when the combination of the medium 30 and the liquid LQ0 is changed, a light streak along the relative movement direction D3 of the medium 30 occurs between the nozzle arrays even if the use range of the first nozzle and the second nozzle is determined based on the density of the specific region 32 of the first TP 31. In particular, when the wettability of the liquid LQ0 to the medium 30 is low, such as when an ultraviolet (UV) ink or a resin ink is discharged onto the medium 30 or an ink is discharged onto a resin medium, the light streak 50 is likely to occur as illustrated in FIG. 14. The wettability of the liquid LQ0 to the medium 30 can be quantified by the contact angle of the droplet placed on the medium. It can be said that the larger the contact angle is, the lower the wettability is, and the smaller the contact angle is, the higher the wettability is. The lower the wettability is, the stronger the repellency of the medium 30 against the liquid LQ0 is, and the higher the wettability is, the weaker the repellency of the medium 30 against the liquid LQ0 is.

FIG. 14 schematically illustrates the behavior of the first liquid LQ1 on the medium 30 when the wettability of the liquid LQ0 to the medium 30 is low. FIG. 14 schematically illustrates the main part of the print head 19 including the first nozzle array 201 at the upstream S1 and the second nozzle array 202 at the downstream S2, and the main part of a print image 45 without the anti-flow dot DT1 with respect to the illustration of FIG. 6. The lower part of FIG. 14 schematically illustrates print data 40 for causing the print head 19 to discharge the first liquid LQ1. For convenience of illustration, FIG. 14 illustrates the nozzle array (201, 202) in the ideal state, but when the nozzle array (201, 202) is not in the ideal state, the first liquid LQ1 is discharged according to the use range determined in the nozzle use range determination processing of FIG. 4.

As described above, the plurality of first nozzles 211 are arranged in the nozzle arrangement direction D3 in the first nozzle array 201, and the plurality of second nozzles 212 are arranged in the nozzle arrangement direction D3 in the second nozzle array 202. The use range of the both nozzles (211, 212) in the overlapping portion 22 are determined according to the first TP 31. In the nozzle arrangement direction D3, the boundary B1 between the first print region AR1 by the first nozzle array 201 and the second print region AR2 by the second nozzle array 202 is within a range of the overlapping portion 22.

Here, as illustrated in the lower part of FIG. 14, it is assumed that the print data 40 indicates that the first liquid LQ1 is discharged seamlessly from the first print region AR1 to the second print region AR2. When the control unit 11 controls drive of the print head 19 according to the print data 40, first, the first liquid LQ1 discharged from the first nozzle array 201 at the upstream S1 lands on the medium 30, and after a predetermined period, the first liquid LQ1 discharged from the second nozzle array 202 at the downstream S2 lands on the medium 30. When the wettability of the liquid LQ0 to the medium 30 is low, the first liquid LQ1 at the first print region AR1 lands before the first liquid LQ1 at the second print region AR2, and as a result, it flows so as to gather in the first print region AR1. In FIG. 14, the landing range of the first liquid LQ1 is indicated by a two-dot chain line at the outside of the first liquid LQ1 in the first print region AR1. As indicated by an arrow in the two-dot chain line, it can be seen that the first liquid LQ1 at the first print region AR1 flows away from the boundary B1. Thus, the first liquid LQ1 that later lands at the second print region AR2 does not merge the first liquid LQ1 at the first print region AR1, and the light streak 50 along the relative movement direction D1 of the medium 30 occurs between the nozzle arrays.

In the present specific example, as illustrated in FIG. 6, the control unit 11 performs control so as to form the anti-flow dots DT1 in the second print region AR2 with the first nozzles 211 included in the first nozzle array 201 at the upstream S1 as the anti-flow dot forming nozzle NZ2. This can suppress the above-described light streak 50.

FIG. 6 schematically illustrates the main part of the print head 19 and the main part of the print image 45. The lower part of FIG. 6 schematically illustrates print data 41 for causing the first nozzle array 201 to discharge the first liquid LQ1 and print data 42 for causing the second nozzle array 202 to discharge the first liquid LQ1. For convenience of illustration, FIG. 14 illustrates the nozzle array (201, 202) in the ideal state, but when the nozzle array (201, 202) is not in the ideal state, the use range determined in the nozzle use range determination processing of FIG. 4 is followed. FIG. 7 schematically illustrates the interval between the anti-flow dots DT1 in the relative movement direction D1.

The nozzle #48 of the first nozzle array 201 illustrated in FIG. 6 is present in the second print region AR2 and present at the end portion at the side of the first print region AR1 in the second print region AR2 in the nozzle arrangement direction D3. FIG. 6 indicates that the nozzle #48 of the first nozzle array 201 is not a non-used nozzle but is used for formation of the anti-flow dot DT1 as the anti-flow dot forming nozzle NZ2. Note that among the plurality of first nozzles 211, a nozzle in the first print region AR1 to #47 (#42 to #47 in FIG. 6) will be called the normal nozzles NZ1. The plurality of first nozzles 211 illustrated in FIG. 6 include a plurality of the normal nozzles NZ1 present in the first print region AR1 and the anti-flow dot forming nozzle NZ2 present at the end portion at the side of the first print region AR1 in the second print region AR2. The control unit 11 is configured to receive setting as to whether or not to form the anti-flow dot DT1 via the operation reception unit 14. Here, it is assumed that the setting described above indicates formation of the anti-flow dot DT1. In this case, the control unit 11 causes the print head 19 to form the plurality of anti-flow dots DT1 not adjacent to each other in the relative movement direction D1 by the first liquid LQ1 discharged from the anti-flow dot forming nozzle NZ2 onto the medium 30 during printing.

In the print data 40, as illustrated in FIG. 7, a pixel PX1 is set as a unit in which dots including the anti-flow dot DT1 are arranged. A pixel is the smallest element that constitutes an image, to which colors can be assigned independently. The pixel PX1 means a unit region defining the formation position of each dot for a certain color such as C. It can also be said that for a certain color, each pixel PX1 is assigned with whether or not one dot is arranged. The fact that the plurality of anti-flow dots DT1 are not adjacent to each other in the relative movement direction D1 means that the anti-flow dots DT1 are not arranged in both of the pixels PX1 adjacent to each other in the relative movement direction D1. When the ratio of the number of dots to the number of pixels is called a recording rate, when the plurality of anti-flow dots DT1 are not adjacent to each other in the relative movement direction D1, the recording rate of the anti-flow dot DT1 is 50% or less in a range larger than 0% in the relative movement direction D1.

As illustrated in FIG. 7, the interval between the anti-flow dots DT1 in the relative movement direction D1 may be variously set to two dots corresponding to the maximum recording rate of 50%, three dots corresponding to the maximum recording rate of 33%, four dots corresponding to the maximum recording rate of 25%, or the like. Note that when the interval between the anti-flow dots DT1 in the print image having the recording rate of 100% is two dots, the anti-flow dots DT1 are formed every other dot in the relative movement direction D1, that is, every other pixel. When the recording rate of the print image is less than 100%, for example, if the position where the normal dot is formed in the print image is the formation position of the anti-flow dot DT1, the anti-flow dot DT1 is formed at the formation position, and is not formed at a position where the dot is not formed in the print image. Therefore, the recording rate of the anti-flow dot DT1 decreases in accordance with the recording rate of the print image.

The intervals between the plurality of anti-flow dots DT1 may be substantially equal intervals. FIG. 7 indicates that the intervals of the anti-flow dots DT1 are equal. Since the anti-flow dot DT1 may be arranged in units of pixels PX1, fluctuation by one dot occurs depending on the recording rate of the anti-flow dot DT1. The “substantially equal interval” means that the fluctuation in the interval between the anti-flow dots DT1 is one dot or less. For example, when the recording rate of the anti-flow dots DT1 is 40%, the intervals between the anti-flow dots DT1 that is substantially equal intervals are two dots or three dots. When the recording rate of the anti-flow dots DT1 is 30%, the intervals between the anti-flow dots DT1 that is substantially equal intervals are three dots or four dots. The reason why the intervals between the anti-flow dots DT1 may be substantially equal intervals is that if there is a variation exceeding substantially equal intervals in the intervals between the plurality of anti-flow dots DT1, the image quality of the print image 45 may be deteriorated. There is a case where the first liquid LQ1 in the first print region AR1 and the first liquid LQ1 in the second print region AR2 merge each other at a portion where the interval described above is narrow, and the first liquid LQ1 in the first print region AR1 and the first liquid LQ1 in the second print region AR2 do not merge each other at a portion where the interval described above is wide. In this case, the print image 45 is disturbed at the boundary B1 part between the first print region AR1 and the second print region AR2, thereby deteriorating the image quality of the print image 45.

The lower part of FIG. 6 illustrates the print data 40 as having a dot recording rate of 100%. The control unit 11 assigns dot data for forming a dot onto the medium 30 to each nozzle 21 based on the print data 40, and assigns the anti-flow dot data to the anti-flow dot forming nozzle NZ2 in addition to these dot data. The dot data is multi-valued data representing a dot formation state, such as binary data representing the presence or absence of formation of the dot. The binary dot data can be data representing, for example, “1” indicating dot formation or “0” indicating no dot. The multi-valued dot data can be four-valued data representing, for example, “3” indicating large dot formation, “2” indicating middle dot formation, “1” indicating small dot formation, or “0” indicating no dot. The anti-flow dot data is dot data for forming the anti-flow dot DT1 at the end portion at the side of the first print region AR1 in the second print region AR2 on the medium 30.

The print data 42 illustrated in FIG. 6 is dot data assigned to the nozzles #4 or later (#4 to #9 in FIG. 6) of the second nozzle array 202 in order to form a dot in the second print region AR2. The print data 41 illustrated in FIG. 6 is dot data in which the anti-flow dot data is added to the dot data assigned to a nozzle of the first nozzle array 201 to #47 (#42 to #47 in FIG. 6) in order to form a dot in the first print region AR1. The anti-flow dot data is assigned to the nozzle #48 of the first nozzle array 201 in order to form the anti-flow dots DT1 not at the first print region AR1 but in the second print region AR2. Therefore, the print data 41 is dot data in which the dot data assigned to the normal nozzle NZ1 present in the first print region AR1 and the anti-flow dot data assigned to the anti-flow dot forming nozzle NZ2 present in the second print region AR2 are combined. Therefore, in the data, the first liquid LQ1 discharged from the nozzle #4 of the first nozzle array 201 is overlapped at the first liquid LQ1 discharged from the anti-flow dot forming nozzle NZ2 at the end portion at the side of the first print region AR1 in the second print region AR2.

When there is no anti-flow dot DT1 when the wettability of the liquid LQ0 to the medium 30 is low, as illustrated in FIG. 14, the first liquid LQ1 that landed at the first print region AR1 earlier than the second print region AR2 flows so as to gather on the medium 30, whereby the light streak 50 occurs. Here, when the first liquid LQ1 is discharged so that dots are continuous in the relative movement direction D1 from the anti-flow dot forming nozzle NZ2 present in the second print region AR2 in the first nozzle array 201, a thick streak such as a black streak occurs. Since the plurality of anti-flow dots DT1 are not adjacent to each other in the relative movement direction D1, the first liquid LQ1 in the first print region AR1 and the first liquid LQ1 in the second print region AR2 appropriately merge, and the light streak 50 is suppressed.

Due to the above action, in the present specific example, it is possible to suppress the light streak along the relative movement direction D1 of the medium 30 between the nozzle arrays from being generated by the flow of dots on the medium 30.

As illustrated in FIG. 8, the size of the anti-flow dot DT1 may be variously set to a large dot, a middle dot, a small dot, or the like. FIG. 8 schematically illustrates the size of the anti-flow dot DT1.

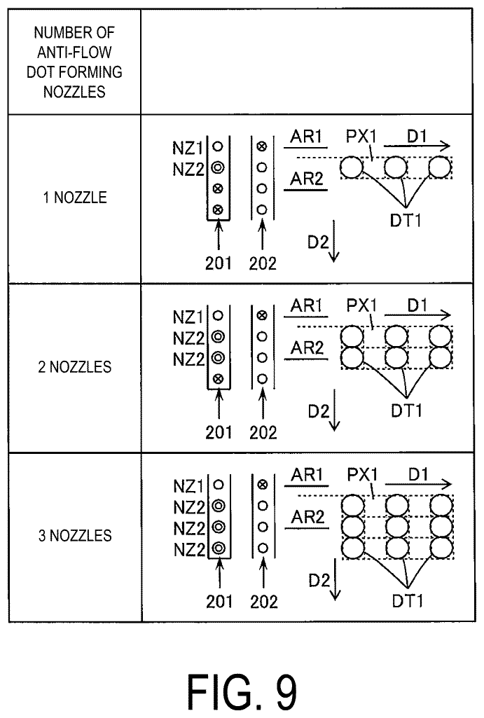

As illustrated in FIG. 9, the number of the anti-flow dot forming nozzles NZ2 may be variously set to one nozzle, two nozzles, three nozzles, or the like. FIG. 9 schematically illustrates the number of the anti-flow dot forming nozzles NZ2. The anti-flow dot forming nozzles NZ2 are set at positions continuous with the arrangement of the normal nozzles NZ1 in the first nozzle array 201. When there is one nozzle of the anti-flow dot forming nozzle NZ2, the anti-flow dot forming nozzle NZ2 is adjacent to the normal nozzle NZ1 in the width direction D2. When there are two nozzles of the anti-flow dot forming nozzle NZ2, the anti-flow dot forming nozzle NZ2 is a combination of a nozzle adjacent to the normal nozzle NZ1 and a nozzle adjacent to the nozzle (not the normal nozzle NZ1) in the width direction D2.

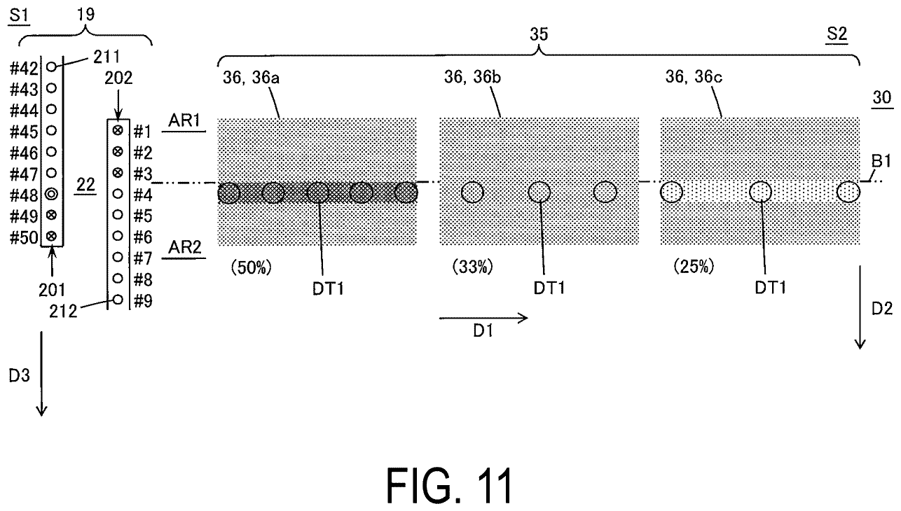

FIG. 10 schematically shows, with a flowchart, adjustment processing performed by the control unit 11 according to the program 12. The adjustment processing is performed on the assumption that the nozzle use range determination processing shown in FIG. 4 was performed. Here, S204 corresponds to the size setting reception step ST4. Step S206 corresponds to the second test pattern printing step ST5 and also corresponds to the anti-flow dot forming step ST3. This is because a second TP 35 including the anti-flow dot DT1 is formed when the streak 50 occurs by the flow of the first liquid LQ1 between the print regions (AR1, AR2) in printing of the first TP 31 not using the anti-flow dot forming nozzle NZ2. Steps S208 to S210 correspond to the interval determination step ST6. FIG. 11 schematically illustrates main parts of the print head 19 and the second test pattern 35. Hereinafter, the second test pattern may be abbreviated as second TP.

Hereinafter, processing of determining the formation condition of the anti-flow dot DT1 for a certain overlapping portion 22 included in the print head 19C will be described. Of course, the nozzle use range determination processing may be performed for each of the plurality of overlapping portions 22 included in the print head 19C, or may be performed for the print heads 19M, 19Y, and 19K.

The adjustment processing may be started when the control unit 110 receives a start instruction for the adjustment processing via the operation reception unit 14. The adjustment processing may be started by using, as a trigger, detection by the control unit 11 that at least one of the type of the medium 30 and the type of the first liquid LQ1 has been changed. By performing second TP forming processing of S208, the printing device 10 forms the second TP 35 when at least one of the type of the medium 30 and the type of the first liquid LQ1 is changed. The wettability of the liquid LQ0 to the medium 30 depends on the combination of the type of the medium 30 and the type of the liquid LQ0. Therefore, when at least one of the type of the medium 30 and the type of the first liquid LQ1 is changed, the degree to which the dots on the medium 30 flow may change. When the second TP 35 is formed by changing at least one of the type of the medium 30 and the type of the first liquid LQ1, the light streak 50 due to the flow of a dot on the medium 30 can be suppressed according to the second TP 35.

When the adjustment processing is started, the control unit 11 causes the display unit 13 to display a user interface screen not illustrated, and receives selection as to whether or not to form the anti-flow dot DT1 via the operation reception unit 14 (S202). For example, when the light streak 50 is generated in the print image 45 (including the first TP 31) formed on the medium 30 according to the determined use range, the user may perform, at the operation reception unit 14, an operation of forming the anti-flow dot DT1. When the light streak 50 is not generated in the print image 45 or there is no problem even if it is generated, the user may perform, at the operation reception unit 14, an operation of not forming the anti-flow dot DT1. When it is selected not to form the anti-flow dot DT1, the control unit 11 ends the adjustment processing.

When it is selected to form the anti-flow dot DT1, the control unit 11 receives a setting operation of the size and the like of the anti-flow dot DT1 via the operation reception unit 14 (S204). Then, the control unit 11 acquires original print data expressing the second TP 35, generates the print data 40 from the original print data according to the setting of the size and the like of the anti-flow dot DT1, and forms the second TP 35 including the anti-flow dot DT1 onto the medium 30 (S206). When the original print data is stored in a storage location such as the storage unit 15, a memory inside and outside the printing device 10, or the like, the control unit 11 can acquire the original print data from the storage location. The control unit 11 may acquire the original print data by receiving the original print data from an external device via the communication I/F 16. Of course, the control unit 11 may generate the original print data by acquiring image data of the second TP from the storage location or the external device and performing image processing such as resolution conversion processing, color conversion processing, halftone processing, and the like for this image data. The processing of generating the original print data in this manner is also included in acquiring the original print data.

As illustrated in FIG. 11, the second TP 35 is formed including the anti-flow dot DT1 by the first liquid LQ1 discharged from the first nozzle array 201 and the second nozzle array 202 to the medium 30. The second TP 35 illustrated in FIG. 11 includes a plurality of individual patterns 36 in which the intervals between the anti-flow dots DT1 in the relative movement direction D1 are varied. For example, an individual pattern 36a includes a plurality of anti-flow dots DT1 having dot intervals by two dots illustrated in FIG. 7. An individual pattern 36b includes a plurality of anti-flow dots DT1 having dot intervals by three dots illustrated in FIG. 7. An individual pattern 36c includes a plurality of anti-flow dots DT1 having dot intervals by four dots illustrated in FIG. 7. FIG. 11 illustrates that indicating the dot recording rate of the individual pattern 36a (50%), indicating the dot recording rate of the individual pattern 36b (33%), and indicating the dot recording rate of the individual pattern 36a (25%) are also formed on the medium 30.

For example, as illustrated in FIG. 8, when there are dot sizes of a large dot, a middle dot, and a small dot, the user can perform, at the operation reception unit 14, a setting operation the large dot, the middle dot, or the small dot as the size of the anti-flow dot DT1. When the setting operation of large dot is received, the control unit 11 causes the print head 19 to form the plurality of anti-flow dots DT1 of the second TP 35 illustrated in FIG. 11 with the large dot. When the setting operation of the small dot is received, the control unit 11 causes the print head 19 to form the plurality of anti-flow dots DT1 of the second TP 35 with the small dot. For example, when the light streak 50 is observed even if the plurality of anti-flow dots DT1 are formed with the small dot, the size of the anti-flow dot DT1 may be increased. Since when the size of the anti-flow dot DT1 increases, the amount of the first liquid LQ1 discharged from the first nozzle array 201 to the end portion at the side of the first print region AR1 in the second print region AR2 increases, the light streak 50 is reduced. Therefore, the streak along the relative movement direction D1 between the nozzle arrays is more appropriately suppressed.

As described above, when the streak 50 due to the flow of the first liquid LQ1 occurs between the print regions (AR1, AR2) in printing based on the use range according to the first TP 31, the control unit 11 forms the plurality of anti-flow dots DT1 not adjacent to each other in the relative movement direction D1 by the first liquid LQ1 discharged from the anti-flow dot forming nozzle NZ2 onto the medium 30.

In S204, the control unit 11 may receive a setting operation the interval between the anti-flow dots DT1 in the relative movement direction D1 via the operation reception unit 14. When the setting operation by two dots illustrated in FIG. 7 is received, the control unit 11 may cause the print head 19 to form the second TP 35 having at least the individual pattern 36a illustrated in FIG. 11. When the setting operation by four dots illustrated in FIG. 7 is received, the control unit 11 may cause the print head 19 to form the second TP 35 having at least the individual pattern 36c illustrated in FIG. 11. For example, when the light streak 50 is observed even if the plurality of anti-flow dots DT1 are formed at intervals by four dots, the intervals between the anti-flow dots DT1 may be narrowed. Since when the interval between the anti-flow dots DT1 is narrowed, the amount of the first liquid LQ1 discharged from the first nozzle array 201 to the end portion at the side of the first print region AR1 in the second print region AR2 increases, the light streak 50 is reduced. Therefore, the streak along the relative movement direction D1 between the nozzle arrays is more appropriately suppressed.

In S204, the control unit 11 may receive a setting operation of the number of the anti-flow dot forming nozzles NZ2 via the operation reception unit 14. When the setting operation of one nozzle illustrated in FIG. 9 is received, the control unit 11 causes the print head 19 to form the plurality of anti-flow dots DT1 of the second TP 35 such that one is arranged in the width direction D2. When the setting operation of three nozzles illustrated in FIG. 9 is received, the control unit 11 causes the print head 19 to form the plurality of anti-flow dots DT1 of the second TP 35 such that three are arranged in the width direction D2. For example, when the light streak 50 is observed even if the anti-flow dot forming nozzle NZ2 is formed with one nozzle, the number of the anti-flow dot forming nozzles NZ2 may be increased. Since when the number of the anti-flow dot forming nozzles NZ2 increases, the amount of the first liquid LQ1 discharged from the first nozzle array 201 to the end portion at the side of the first print region AR1 in the second print region AR2 increases, the light streak 50 is reduced. Therefore, the streak along the relative movement direction D1 between the nozzle arrays is more appropriately suppressed.

After printing the second TP 35, the control unit 11 acquires a read result of the second TP 35 on the medium 30 (S208). When the user visually evaluates the second TP 35, the control unit 11 may acquire, as a read result, a result selected from the individual patterns 36a to 36c and the like via the operation reception unit 14. In the individual pattern 36a illustrated in FIG. 11, a streak darker than that in the periphery occurs along the relative movement direction D1 by the plurality of anti-flow dots DT1 having intervals by two dots. In the individual pattern 36c illustrated in FIG. 11, a streak lighter than that in the periphery occurs along the relative movement direction D1 by the plurality of anti-flow dots DT1 having intervals by four dots. In the individual pattern 36b illustrated in FIG. 11, a streak having a different shade is not observed along the relative movement direction D1 by the plurality of anti-flow dots DT1 having intervals of three dots. Therefore, the user can notify the control unit 11 of the selection result by selecting corresponding to the individual pattern 36b having the best image quality (33%) and operating the operation reception unit 14. The processing of acquiring the selection result of the second TP 35 from the user corresponds to the acquisition of the read result of the second TP 35 in S208. The second TP 35 may be not visually read by the user by read by a reading device not illustrated such as a scanner or a colorimeter, and read image data and colorimetric values as a read result may be transmitted from the reading device to the printing device 10 through the communication I/F 16. That is, in S208, the control unit 11 may acquire the read result of the second TP 35 from the reading device.

After acquiring the read result, the control unit 11 determines the formation condition for the anti-flow dot DT1 according to the read result and saves the determination content (S210). When acquiring the selection result of the second TP 35 from the user, the control unit 11 determines the interval between the anti-flow dots DT1 applied to the formation of the print image 45 to be an interval corresponding to the selection result. Thereafter, since the print control processing illustrated in FIG. 13 is performed, it can be said that the control unit 11 determines the interval between the anti-flow dots DT1 applied to the anti-flow dot forming step ST3 based on the second TP 35. For example, if the individual pattern 36b is selected by the user, the control unit 11 determines the interval between the anti-flow dots DT1 to be applied to the formation of the print image 45 to be three dots. The control unit 11 may perform the adjustment processing shown in FIG. 10 for all the overlapping portions 22 of the print heads 19C, 19M, 19Y, and 19K and determine the formation condition of the anti-flow dot DT1 for each overlapping portion 22. Thereafter, when executing printing in response to a user's instruction or the like, the control unit 11 forms the anti-flow dot DT1 under the formation condition described above according to the print control processing shown in FIG. 12.

As illustrated in FIG. 11, when the interval between the anti-flow dots DT1 is narrowed, the amount of the first liquid LQ1 discharged from the first nozzle array 201 to the end portion at the side of the first print region AR1 in the second print region AR2 increases. When a light streak is observed as in the individual pattern 36c, when the interval between the anti-flow dots DT1 is narrowed as in the individual pattern 36b, the light streak is reduced. Therefore, the streak along the relative movement direction D1 between the nozzle arrays is more appropriately suppressed.

FIG. 12 schematically shows, with a flowchart, print control processing performed by the control unit 11 according to the program 12. The print control processing is performed on the assumption that the adjustment processing illustrated in FIG. 10 was performed. Here, S306 to S308 correspond to the anti-flow dot forming step ST3. The print control processing starts when the control unit 110 receives a start instruction of the print control processing via the operation reception unit 14.

When the print control processing is started, the control unit 11 acquires the print data 40 expressing an image (S302). This print data 40 is not limited to data having a dot recording rate of 100%, and means data expressing various images having a dot recording rate of less than 100%, such as a natural image or a photographic image for the user to display in a room or sell, or a document image presented to another person such as a line drawing for presentation.

After acquiring the print data 40, the control unit 11 assigns, based on the print data 40, dot data to each nozzle 21 used for printing (S304). For example, as illustrated in FIG. 6, the control unit 11 assigns the dot data of the first print region AR1 to a nozzle of the first nozzle array 201 to #47, and assigns the dot data of the second print region AR2, that is, the print data 42 to the nozzle #4 or later of the second nozzle array 202. At this time point, the print data 42 for the second nozzle array 202 is generated.

Furthermore, the control unit 11 assigns the anti-flow dot data to the anti-flow dot forming nozzle NZ2 based on the print data 40 (S306). For example, if the position where a normal dot is assigned to the end portion at the side of the first print region AR1 in the second print region AR2 in the print data 42 is an assignment position of the anti-flow dot DT1, the control unit 11 performs assignment to the assignment position. In this manner, the print data 41 for the first nozzle array 201 is generated.

Finally, the control unit 11 causes the print head 19 to discharge the liquid LQ0 according to the print data 40 to form the print image 45 onto the medium 30 (S308). Focusing on the print head 19C, the control unit 11 causes the first liquid LQ1 of C to be discharged from the first nozzle array 201 according to the print data 41, and causes the first liquid LQ1 of C to be discharged from the second nozzle array 202 according to the print data 42. At this time, at the end portion at the side of the first print region AR1 of the second print region AR2, the plurality of anti-flow dots DT1 not adjacent to each other in the relative movement direction D1 are formed by the first liquid LQ1 of C discharged from the anti-flow dot forming nozzle NZ2 onto the medium 30.

As described above, when the streak 50 due to the flow of the first liquid LQ1 occurs between the print regions (AR1, AR2) in printing based on the use range according to the first TP 31, the control unit 11 forms the above-described plurality of anti-flow dots DT1.

As described above, since the anti-flow dot DT1 is formed by the first liquid LQ1 discharged to the second print region AR2 from the anti-flow dot forming nozzle NZ2 of the first nozzle array 201 for the first print region AR1, the light streak 50 as illustrated in FIG. 14 is suppressed. Since the plurality of anti-flow dots DT1 are not adjacent to each other in the relative movement direction D1, the first liquid LQ1 in the first print region AR1 and the first liquid LQ1 in the second print region AR2 appropriately merge, and a thick streak is also suppressed from being generated. Therefore, in the present specific example, it is possible to suppress the light streak along the relative movement direction D1 of the medium 30 between the nozzle arrays from being generated by the flow of dots on the medium 30.

### (3) Modifications

The present disclosure includes various modifications.

The printing device 10 is not limited to a line type printing device, and may be a serial type printing device. For example, when the print head 19 is mounted at a carriage movable along a main scanning direction, the print head 19 may include the first nozzle array 201 and the second nozzle array 202. In this case, the relative movement direction D1 is a direction along the main scanning direction, and the transfer unit 17 moves the print head 19 in a direction opposite to the relative movement direction D1 without moving the medium 30. Therefore, the transfer unit 17 relatively moves the medium 30 in the relative movement direction D1 intersecting the nozzle arrangement direction D3 with reference to the print head 19.

Although the second TP 35 illustrated in FIG. 11 includes a plurality of individual patterns 36 in which the intervals between the anti-flow dots DT1 in the relative movement direction D1 are varied, the second TP is not limited to the example of FIG. 11. For example, when the second TP includes a plurality of individual patterns in which the size of the anti-flow dot DT1 is varied, the control unit 11 can determine the size of the anti-flow dot DT1 applied to the anti-flow dot forming step ST3. When the second TP includes a plurality of individual patterns in which the number of the anti-flow dot forming nozzles NZ2 is varied, the control unit 11 can determine the number of the anti-flow dot forming nozzles NZ2 applied to the anti-flow dot forming step ST3.

As illustrated in FIG. 13, the control unit 11 may perform control of changing the anti-flow dot forming nozzle NZ2 to the normal nozzle NZ1. This is because an appropriate use range of the first nozzle 211 and the second nozzle 212 may change by a change in the state, environment, and the like of the nozzle 21.

FIG. 13 schematically shows, with a flowchart, another example of print control processing performed by the control unit 11 according to the program 12. This print control processing is also started when the control unit 110 receives a start instruction of the print control processing via the operation reception unit 14. In the flow of FIG. 13, a user interface (UI) screen 500 and a role of the nozzle 21 during printing are also illustrated.

When the print control processing is started, the control unit 11 causes the display unit 13 to display the UI screen 500 (S402). The UI screen 500 includes a selection item 501 for forming the anti-flow dot DT1 by the anti-flow dot forming nozzle NZ2, a selection item 502 for changing the anti-flow dot forming nozzle NZ2 to the normal nozzle NZ1, and an OK button not illustrated. The operation reception unit 14 can receive an operation of any one of the selection items 501 and 502. The user can select any one of the selection items 501 and 502 by operating any one of the selection items 501 and 502 and operating the OK button. When the selection item 502 is selected, the operation reception unit 14 receives a change operation from the anti-flow dot forming nozzle NZ2 to the normal nozzle NZ1. The control unit 11 receives a selection operation of any one of the selection items 501 and 502 via the operation reception unit 14.

When the OK button is operated, the control unit 11 branches the processing according to the selection operation for the selection item 501 or 502 (S404). When receiving the selection operation of the selection item 501, the control unit 11 causes the print head 19 to form the plurality of anti-flow dots DT1 not adjacent to each other in the relative movement direction D1 by the anti-flow dot forming nozzle NZ2 during printing as shown in the flow (S406). On the other hand, when receiving the selection operation of the selection item 502, the control unit 11 changes the anti-flow dot forming nozzle NZ2 to the normal nozzle NZ1 and causes the print head 19 to form the normal dot as shown in the flow (S408). Therefore, when the change operation from the anti-flow dot forming nozzle NZ2 to the normal nozzle NZ1 is received, the control unit 11 changes the anti-flow dot forming nozzle NZ2 to the normal nozzle NZ1 and controls the discharge of the liquid LQ0 by the print head 19.

When the anti-flow dot forming nozzle NZ2 is changed to the normal nozzle NZ1, the amount of the first liquid LQ1 discharged from the first nozzle array 201 to the end portion at the side of the first print region AR1 in the second print region AR2 increases. This can reduce a light streak when the light streak is observed even if the anti-flow dot DT1 is formed.

### (4) Conclusions

As described above, according to the present disclosure, with various aspects, it is possible to provide a configuration and the like configured to suppress a light streak along the relative movement direction of the medium between the nozzle arrays from being generated by the flow of dots on the medium. Of course, the above-described basic actions and effects can be obtained also in an aspect including only the constituent elements according to the independent claims.

A configuration in which the configurations disclosed in the above-described examples are replaced with one another or the combinations are changed, a configuration in which a known technology and the configurations disclosed in the above-described examples are replaced with one another or the combinations are changed, or the like can be carried out. The present disclosure also includes these configurations.

What is claimed is:

1. A printing device comprising:
a print head including a first nozzle array in which a plurality of first nozzles configured to
discharge a first liquid onto a medium are arranged in a predetermined nozzle arrangement direction, and a second nozzle array in which a plurality of second nozzles configured to discharge the first liquid onto the medium are arranged in the nozzle arrangement direction;
a transfer unit configured to relatively move the medium in a relative movement direction intersecting the nozzle arrangement direction with reference to the print head; and
a control unit configured to control discharge of a liquid containing the first liquid by the print head, wherein
the print head includes an overlapping portion in which a part of the first nozzle array and a part of the second nozzle array overlap as viewed from the relative movement direction,
in the overlapping portion, the first nozzle array is positioned more upstream in the relative movement direction than the second nozzle array,
a boundary between a first print region by the first nozzle array and a second print region by the second nozzle array is within a range of the overlapping portion in the nozzle arrangement direction,
the plurality of first nozzles include a normal nozzle present in the first print region and an anti-flow dot forming nozzle present at an end portion at a side of the first print region in the second print region, and
the control unit causes the print head to form a plurality of anti-flow dots not adjacent to each other in the relative movement direction by the first liquid discharged from the anti-flow dot forming nozzle to the medium during printing.

2. The printing device according to claim 1, further comprising:
an operation reception unit configured to receive a change operation from the anti-flow dot forming nozzle to the normal nozzle, wherein
when the change operation is received, the control unit changes the anti-flow dot forming nozzle to the normal nozzle and controls discharge of the liquid by the print head.

3. The printing device according to claim 1, further comprising:
an operation reception unit configured to receive a setting operation a size of the anti-flow dot, wherein
when the setting operation is received, the control unit causes the print head to form the plurality of anti-flow dots with the size.

4. A printing method of relatively moving a medium in a relative movement direction intersecting a predetermined nozzle arrangement direction with reference to a print head and discharging a liquid containing a first liquid from the print head to the medium, wherein
the print head includes a first nozzle array in which a plurality of first nozzles configured to
discharge the first liquid onto the medium are arranged in the nozzle arrangement direction, and a second nozzle array in which a plurality of second nozzles configured to discharge the first liquid onto the medium are arranged in the nozzle arrangement direction,
the print head includes an overlapping portion in which a part of the first nozzle array and a part of the second nozzle array overlap as viewed from the relative movement direction,
in the overlapping portion, the first nozzle array is positioned more upstream in the relative movement direction than the second nozzle array,
a boundary between a first print region by the first nozzle array and a second print region by the second nozzle array is within a range of the overlapping portion in the nozzle arrangement direction,
the plurality of first nozzles include a normal nozzle present in the first print region and an anti-flow dot forming nozzle present at an end portion at a side of the first print region in the second print region, and
when a streak due to a flow of the first liquid is generated between the first print region and the second print region in printing not using the anti-flow dot forming nozzle, a plurality of anti-flow dots not adjacent to each other in the relative movement direction are formed by the first liquid discharged from the anti-flow dot forming nozzle to the medium.

5. A printing method of relatively moving a medium in a relative movement direction intersecting a predetermined nozzle arrangement direction with reference to a print head and discharging a liquid containing a first liquid from the print head to the medium, wherein
the print head includes a first nozzle array in which a plurality of first nozzles configured to
discharge the first liquid onto the medium are arranged in the nozzle arrangement direction, and a second nozzle array in which a plurality of second nozzles configured to discharge the first liquid onto the medium are arranged in the nozzle arrangement direction,
the print head includes an overlapping portion in which a part of the first nozzle array and a part of the second nozzle array overlap as viewed from the relative movement direction,
in the overlapping portion, the first nozzle array is positioned more upstream in the relative movement direction than the second nozzle array,
where n is an integer of 2 or more and a pair of the first nozzle and the second nozzle in which a position in the overlapping portion of the first nozzle array and a position in the overlapping portion of the second nozzle array are in a corresponding relationship is defined as a nozzle pair, the overlapping portion has n sets of the nozzle pairs arranged in the nozzle arrangement direction,
the printing method includes
a first test pattern printing step for, when a first test pattern for determining a use range of the first nozzle and the second nozzle in the overlapping portion is printed on the medium, printing the first test pattern, where m is an integer of 0 or more and less than n, and a number of specific nozzle pairs using the first nozzle and the second nozzle among the nozzle pairs for discharge of the first liquid is m pairs, and
a use range determination step for determining the use range based on a density of a specific region from a first print position to a second print position,
the first print position is a print position of the first nozzle closest to a side of a second print region by the second nozzle array in a first print region by the first nozzle array in the first test pattern printed on the medium,
the second print position is a print position of the second nozzle positioned closest to a side of the first print region in the second print region in the first test pattern printed on the medium,
the plurality of first nozzles include a normal nozzle present in the first print region and an anti-flow dot forming nozzle present at an end portion at the side of the first print region in the second print region, and
the printing method further includes
an anti-flow dot forming step for, when a streak due to a flow of the first liquid is generated between the first print region and the second print region in printing based on the use range, forming a plurality of anti-flow dots not adjacent to each other in the relative movement direction by the first liquid discharged from the anti-flow dot forming nozzle to the medium.

6. The printing method according to claim 5, further comprising:
a size setting reception step for receiving setting of a size of the anti-flow dot, wherein
in the anti-flow dot forming step, the plurality of anti-flow dots are formed with the size.

7. The printing method according to claim 5, further comprising:
a second test pattern printing step for forming a second test pattern formed including the anti-flow dot by the first liquid discharged from the first nozzle array and the second nozzle array onto the medium, the second test pattern including a plurality of individual patterns in which intervals between the anti-flow dots in the relative movement direction are varied; and
an interval determination step for determining the interval between the anti-flow dots applied to the anti-flow dot forming step based on the second test pattern.

8. The printing method according to claim 7, wherein in the second test pattern printing step, the second test pattern is formed when at least one of a type of the medium and a type of the first liquid is changed.
